(19) United States
(12) Patent Application Publication
(10) Pub. No.: US 2026/0211984 A1
(43) Pub. Date: Jul. 23, 2026

(54) Digital Watermarking for Link between NFT and Associated Digital Content

(71) Applicant: Digimarc Corporation, Beaverton, OR (US)

(72) Inventors: Dominique Guinard, Troistorrents (CH); Chément Hecquet, Lausanne (CH)

(21) Appl. No.: 19/141,647

(22) PCT Filed: Nov. 29, 2023
(86) PCT No.: PCT/US2023/081649

§ 371 Date: Jun. 20, 2025

Related U.S. Application Data
(60) Provisional application No. 63/435,043, filed on Dec. 23, 2022.
(60) Provisional application No. 63/445,635, filed on Feb. 14, 2023.

(51) Int. Cl. G06F 21/16; G06F 21/64; H04L 9/08; H04L 9/32

(52) U.S. Cl. CPC G06F 21/16; G06F 21/64; H04L 9/0825; H04L 9/3236; H04L 9/3247

(57) ABSTRACT

The present disclosure relates to generally to digital watermarking, non-fungible tokens (“NFTs”) and smart contracts. One aspect of the disclosure describes embedding a digital watermark into digital content, the digital watermark includes a message that can be used to prove authenticity, origin, content integrity and/or a creator associated with an NFT. This technology will help protect and authenticate an NFT and its digital content. Related technology and methodologies are also described.

### RELATED APPLICATION DATA

This application claims the benefit of U.S. Provisional Patent Application Nos. 63/445,635, filed Feb. 14, 2023, and 63/435,043, filed Dec. 23, 2022. This application is generally related to assignee's U.S. patent application Ser. No. 17/992,823, filed Nov. 22, 2022, and PCT Application No. PCT/US22/50767, filed Nov. 22, 2022 (published as WO 2023/096924). Each of the above patent documents is hereby incorporated herein by reference in its entirety.

### TECHNICAL FIELD

The disclosed technology relates generally to complex signal processing including digital watermarking, blockchains, non-fungible tokens, and authentication.

### BACKGROUND AND SUMMARY

So-called “non-fungible tokens” or “NFTs” are being sold for digital content, such as digital artwork, digital images, 3D models, digital photographs and digital designs, but a link between such digital content and its associated NFT is weak—merely a link in the NFT's metadata. This puts the association (via the link) between the NFT and its underlying digital content at risk. In this patent document, we use the term “digital content” to mean one or more digital assets associated with an NFT. Examples of digital assets include images and pictures, digital art, digital images generated by Artificial Intelligence (“AI”), graphics, logos, digital designs, 3D models, documents and presentations, video (including one or more video frames), audio, etc.

One aspect of the disclosure describes embedding a so-called digital watermark into digital content, the digital watermark including a signed message that can be used to prove origin, content integrity and creator of an NFT. This technology will help protect from, e.g., “right-click” copying the digital content, as such a copy of the digital content would also contain the original watermark hence proving it the digital content was copied.

Before we go further, let's take a step back and review some blockchain, NFT and digital watermarking concepts.

A blockchain can be analogized as a “digital ledger” that records information about transactions. The digital ledger is stored online in a decentralized manner. Decentralization generally means that a copy of the blockchain (or the “digital ledger”) is stored in many online places at the same time and does not have one central point that controls the content. Another way to look at blockchains is to view them as a distributed database that maintains a growing list of ordered records, called “blocks.” These blocks are linked using cryptography. For example, each block contains a cryptographic hash of the previous block in the chain, and, e.g., a timestamp, and perhaps transaction data. The previous block hash links the blocks together and prevents any block from being altered or, e.g., a block being inserted between two existing blocks. A popular use of blockchains is in recording and storing transaction information for cryptocurrencies such as Bitcoin.

“Distributed Ledger Technology” is a more general version of the blockchain. A DLT typically includes: a public or private distributed ledger, a consensus algorithm (to ensure all copies of the ledger are identical) and, optionally, a framework for incentivizing and rewarding network participation. A consensus algorithm is generally a method or technology of synchronizing the ledger across a distributed system.

A related term is an NFT or “non-fungible token”. Such non-fungible tokens are a type of assets on a blockchain characterized by being unique and non-interchangeable with one another for equal value. For example, a non-fungible token can be a video game asset, a work of art, a collectible card or image, or any other “unique” object stored and managed on a blockchain.

Another related term includes “smart contract,” which is an agreement or set of rules (e.g., contained in a software program) that govern a transaction or event. A smart contract is typically stored on the blockchain and can be executed automatically as part of a transaction or event.

Now onto digital watermarking. The term “steganography” generally implies data hiding. One form of data hiding includes digital watermarking. For purposes of this disclosure, the terms “digital watermark,” “watermark” and “data hiding” are used interchangeably. We sometimes use the terms “embedding,” “embed,” and data hiding” to mean modulating or transforming data representing digital content to include information therein. For example, data hiding may seek to hide or embed an information signal (e.g., a plural bit payload or a modified version of such, e.g., a 2-D error corrected, spread spectrum signal) in a host signal. This can be accomplished, e.g., by modulating a host signal (e.g., representing digital content) in some fashion to carry the information signal. Similarly, we sometimes use the terms “decode,” “detect” and “read” (and various forms thereof) to mean analyzing content to obtain a payload or signal element embedded therein.

Digimarc Corporation headquartered in Beaverton, Oregon, USA, is a leader in the field of digital watermarking. Some of Digimarc's work in steganography, data hiding and digital watermarking is reflected, e.g., in U.S. Pat. Nos. 11,410,262; 11,410,261; 11,188,996; 11,188,996; 11,062,108; 10,652,422; 10,453,163; 10,282,801; 6,947,571; 6,912,295; 6,891,959. 6,763,123; 6,718,046; 6,614,914; 6,590,996; 6,408,082; 6,122,403 and 5,862,260, and in published PCT specification WO2016153911. Each of these patent documents is hereby incorporated by reference herein in its entirety. Of course, a great many other approaches are familiar to those skilled in the art. The artisan is presumed to be familiar with a full range of literature concerning steganography, data hiding and digital watermarking.

One aspect of the disclosure is an image processing method comprising: obtaining digital content comprising visual elements; minting a non-fungible token (“NFT”) associated with the digital content, said minting yielding a token identifier generated by a smart contract deployed on a Distributed Ledger Technology (“DLT”), the smart contract having an associated smart contract address and the DLT being associated with a DLT identification; generating a hash of the token identifier, the smart contract address and the DLT identification, the hash comprising a reduce-bit representation of the token identifier, the smart contract address and the DLT identification; and using a digital watermark embedder, embedding the hash within the digital content as a digital watermark payload, whereby the digital watermarked digital content comprises a link between the digital content and the NFT via the hash.

Another aspect of the disclosure is an image processing method comprising: obtaining digital content comprising visual elements, the digital content comprising a first digital watermark embedded therein, the first digital watermark comprising a first plural-bit payload carrying a creator signature comprising a cryptographic relationship between a smart contract address and a target blockchain according to a first private key, the digital content being associated with a non-fungible token (“NFT”); decoding the first plural-bit payload to obtain the creator signature; embedding a second digital watermark within the digital content, the second digital watermark comprising a second plural-bit payload carrying a first owner signature, the first owner signature comprising a hashed version of the creator signature using a second private key, in which the embedding of the second digital watermark is associated with ownership transfer of the digital content from the creator to the first owner.

Yet another aspect of the disclosure includes a method of creating a cryptographic ownership chain for a non-fungible token using digital watermarking. The method comprises: obtaining digital content comprising visual elements, the digital content comprising a first digital watermark embedded therein, the first digital watermark comprising a first plural-bit payload carrying a creator signature comprising a cryptographic relationship between smart contract address and target blockchain according to a first private key, the digital content associated with a non-fungible token (“NFT”); decoding the first plural-bit payload to obtain the creator signature; embedding a second digital watermark within the digital content, the second digital watermark comprising a second plural-bit payload carrying a first owner signature, the first owner signature comprising a hashed version of the creator signature using a second private key, in which the embedding of the second digital watermark is associated with ownership transfer of the digital content from the creator to the first owner.

Still another aspect of the disclosure is a method comprising: providing two different digital watermarks to help associate information with non-fungible tokens (“NFTs”), a first of the two different digital watermarks comprising a synchronization signal aligned at a first starting point relative to host digital content, the first starting point indicating a first NFT marketplace, in which the first of the two different digital watermarks does not carry a payload component, and in which the second of the two different digital watermarks comprises only a payload component and no synchronization signal, in which the payload component relies upon the synchronization signal of the first of the two different digital watermarks for decoding, and in which the payload component comprises NFT ownership information; using a digital watermark decoder, searching digital content to locate the first of the two different digital watermarks and the second of the two different digital watermarks, and making a determination according to decoding results yielded by the digital watermark decoder as follows: when only the first of the two different digital watermarks is found, determining the first NFT marketplace, and when both the first of the two different digital watermarks and the second of the two different digital watermarks are found, determining a current owner of the digital watermark from the NFT ownership information.

Another aspect of the disclosure is an image processing method comprising: obtaining digital content comprising visual elements; minting a non-fungible token (“NFT”) associated with the digital content, said minting yielding a token identifier corresponding to a smart contract, hosting address of the NFT and a Distributed Ledger Technology (“DLT”) identifier; generating data representing the token identifier, the hosting address and the DLT identifier; embedding, using a digital watermark embedder, the generated data within the digital content, said embedding altering at least some portions of the visual elements, said embedding yielding digital watermarked digital content; and publishing the digital watermarked digital content on the hosting address of the NFT. In some implementations, the generated data comprises a hash of the token identifier, the hosting address and the DLT identifier, in which the hash comprises a reduced-bit representation of the token identifier, the hosting address and the DLT identifier.

A related image processing method may also include: using one or more multi-core processors: receiving data representing the digital watermarked digital content from the hosting address; analyzing, using a digital watermark decoder, the data representing the digital watermarked digital content to decode the hash, said analyzing yielding a decoded hash; scraping information from data associated with the hosting address of the NFT, said scraping yielding a scraped token identifier, a scraped hosting address and a scraped DLT identifier; generating a comparison hash based on the scraped token identifier, the scraped hosting address and the scraped DLT identifier; and comparing the decoded hash with the comparison hash to determine whether the NFT is authentic.

Additional aspects, features, and advantages will be readily apparent with reference to the following figures and Detailed Description.

### BRIEF DESCRIPTION OF THE DRAWINGS

FIG. 1 is a block diagram of a signal encoder for encoding a data signal into host digital content.

FIG. 2 is a block diagram of a signal decoder for extracting a data signal from host digital content.

FIG. 3 is a flow diagram illustrating operations of a signal generator.

FIG. 4 is a block diagram illustrating an example of private/public key-based signature generation.

FIGS. 5A-5P are screen shots showing an NFT verification system.

### DETAILED DESCRIPTION

There are two (2) main sections that follow in this Detailed Description (I. Signal Encoding and Decoding, and II. Digital Watermarking for Proof of NFT Authenticity). These sections and their assigned headings are provided merely to help organize the Detailed Description. Of course, description and implementations under one such section is intended to be combined and implemented with description and implementations from the other such section headings. Thus, the section and headings in this document should not be interpreted as limiting the scope of the description.

### I. Signal Encoding and Decoding

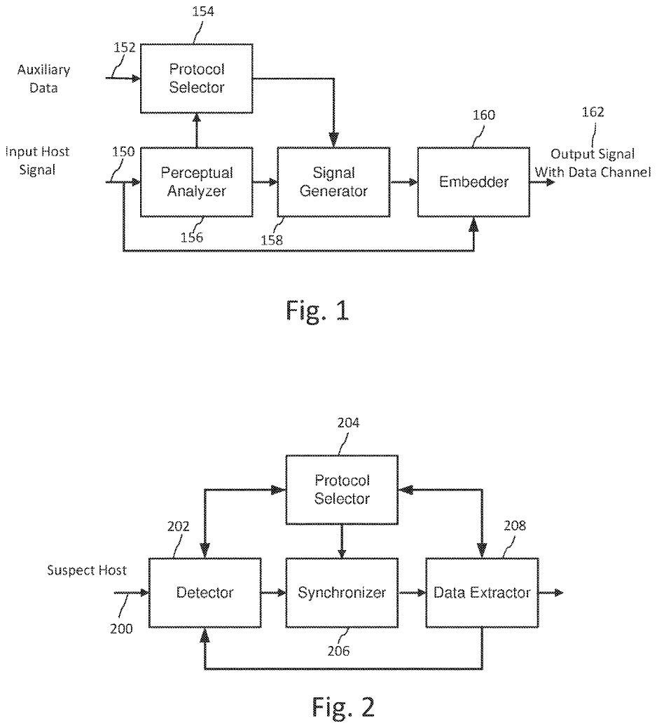

FIG. 1 is a block diagram of a signal encoder for encoding a signal within digital content (e.g., digital image, digital video, metaverse asset, digital artwork, digital 3D models, digital photographs, digital audio, digital graphics or designs). We sometimes refer to the signal as an “encoded signal,” “embedded signal” or “digital watermark signal”. FIG. 2 is a block diagram of a compatible signal decoder for extracting a payload from a signal encoded within the digital content.

Encoding and decoding is typically applied digitally. For example, the encoder generates an output including an embedded signal that can be converted to a rendered form, such as viewable digital content, PDF, displayed image or video, or other viewable digital form. Prior to decoding, and if in an analog form, a decoding device obtains an image or stream of images, and converts (if in analog form) it to an electronic signal, which is digitized and processed by signal decoding modules.

Inputs to the signal encoder include a host signal 150 and auxiliary data 152. The host signal in this context can be the target digital content. The objectives of the encoder include encoding a robust signal with desired capacity per unit of host signal, while maintaining perceptual quality within a perceptual quality constraint. In some cases, there may be very little variability or presence of a host signal, in which case, there is little host interference, on the one hand, yet little host content in which to mask the presence of the data channel visually. Some examples include a region of digital content that is devoid of much pixel variability (e.g., a single, uniform color).

The auxiliary data 152 includes the variable data information (e.g., payload) to be conveyed in the data channel, possibly along with other protocol data used to facilitate the communication.

The protocol defines the manner in which the signal is structured and encoded for robustness, perceptual quality or data capacity. For any given application, there may be a single protocol, or more than one protocol. Examples of multiple protocols include cases where there are different versions of the channel, different channel types (e.g., several signal layers within a host signal). Different protocol versions may employ different robustness encoding techniques or different data capacity. Protocol selector module 154 determines the protocol to be used by the encoder for generating a data signal. It may be programmed to employ a particular protocol depending on the input variables, such as user control, application specific parameters, or derivation based on analysis of the host signal.

Perceptual analyzer module 156 analyzes the input host signal to determine parameters for controlling signal generation and embedding, as appropriate. It is not necessary in certain applications, while in others it may be used to select a protocol and/or modify signal generation and embedding operations. For example, when encoding in a host signal that will be printed or displayed, the perceptual analyzer 156 may be used to ascertain color content and masking capability of the host digital content.

The embedded signal may be included in one of the layers or channels of the digital content, e.g., corresponding to:
Luminance, Chrominance, or in a CIELAB channel (L*, a*, b*);
YUV channel;
a color channel of the digital content, e.g., Red Green Blue (RGB);
components of a color model (Lab, HSV, HSL, etc.);
channels corresponding to Cyan, Magenta, Yellow and/or Black, a spot color layer (e.g., corresponding to a Pantone color), which are specified to be used to print the digital content;
a coating (e.g., varnish, UV layer, lacquer, sealant, extender, primer, etc.);
other material layer (metallic substance, e.g., metallic ink or stamped foil where the embedded signal is formed by stamping holes in the foil or removing foil to leave dots of foil); etc.

The above are typically specified in a digital content file, and are manipulated by an encoder. For example, an encoder is implemented as software modules of a plug-in to Adobe Photoshop or Illustrator processing software. Such software can be specified in terms of image layers or image channels. The encoder may modify existing layers, channels or insert new ones. A plug-in can be utilized with other image processing software, e.g., for Adobe Illustrator.

The perceptual analysis performed in the encoder depends on a variety of factors, including color or colors of the embedded signal, resolution of the encoded signal, dot structure and screen angle used to print image layer(s) with the encoded signal, content within the layer of the encoded signal, content within layers under and over the encoded signal, etc. The perceptual analysis may lead to the selection of a color or combination of colors in which to encode the signal that minimizes visual differences due to inserting the embedded signal in an ink layer or layers within the digital content. This selection may vary per embedding location of each signal element. Likewise, the amount of signal at each location may also vary to control visual quality. The encoder can, depending on the associated print technology in which it is employed, vary embedded signal by controlling parameters such as:
dot shape,
signal amplitude at a dot,
ink quantity at a dot (e.g., dilute the ink concentration to reduce percentage of ink),
structure and arrangement of dot cluster or “bump” shape at a location of a signal element or region of elements. An arrangement of ink applied to x by y two-dimensional array of neighboring locations can be used to form a “bump” of varying shape or signal amplitude, as explained further below.

The ability to control printed dot size and shape is a particularly challenging issue and varies with print technology. Dot size can vary due to an effect referred to as dot gain. The ability of a printer to reliably reproduce dots below a particular size is also a constraint.

The encoded signal may also be adapted according to a blend model which indicates the effects of blending the ink of the signal layer with other layers and the substrate.

In some cases, a designer may specify that the encoded signal be inserted into a particular layer. In other cases, the encoder may select the layer or layers in which it is encoded to achieve desired robustness and visibility (visual quality of the digital content in which it is inserted).

The output of this analysis, along with the rendering method (display or printing device) and rendered output form (e.g., ink and substrate) may be used to specify encoding channels (e.g., one or more color channels), perceptual models, and signal protocols to be used with those channels. Please see, e.g., the work on visibility and color models used in perceptual analysis in U.S. application Ser. No. 14/616,686 (U.S. Pat. No. 9,380,186), Ser. No. 14/588,636 (U.S. Pat. No. 9,401,001) and Ser. No. 13/975,919 (U.S. Pat. No. 9,449,357), Patent Application Publication 20100150434 (now U.S. Pat. No. 9,449,357), and U.S. Pat. No. 7,352,878, which are each hereby incorporated by reference in its entirety.

The signal generator module 158 operates on the auxiliary data and generates a data signal according to the protocol. It may also employ information derived from the host signal, such as that provided by perceptual analyzer module 156, to generate the signal. For example, the selection of data code signal and pattern, the modulation function, and the amount of signal to apply at a given embedding location may be adapted depending on the perceptual analysis, and in particular on the perceptual model and perceptual mask that it generates. Please see below and the incorporated patent documents for additional aspects of this process.

Embedder module 160 takes the data signal and modulates it onto a channel by combining it with the host signal. The operation of combining may be an entirely digital signal processing operation, such as where the data signal modulates the host signal digitally, may be a mixed digital and analog process or may be purely an analog process (e.g., where rendered output layers are combined). As noted, an encoded signal may occupy a separate layer or channel of the digital content file. This layer or channel may get combined into an image in the Raster Image Processor (RIP) prior to printing or may be combined as the layer is printed under or over other image layers on a substrate.

There are a variety of different functions for combining the data and host in digital operations. One approach is to adjust the host signal value as a function of the corresponding data signal value at an embedding location, which is controlled according to the perceptual model and a robustness model for that embedding location. The adjustment may alter the host channel by adding a scaled data signal or multiplying a host value by a scale factor dictated by the data signal value corresponding to the embedding location, with weights or thresholds set on the amount of the adjustment according to perceptual model, robustness model, available dynamic range, and available adjustments to elemental ink structures (e.g., controlling halftone dot structures generated by the RIP). The adjustment may also be altering by setting or quantizing the value of a pixel to particular signal element value.

As detailed further below, the signal generator produces a data signal with data elements that are mapped to embedding locations in the data channel. These data elements are modulated onto the channel at the embedding locations. Again please see the documents incorporated herein for more information on variations.

The operation of combining a signal with other digital content may include one or more iterations of adjustments to optimize the modulated host for perceptual quality or robustness constraints. One approach, for example, is to modulate the host so that it satisfies a perceptual quality metric as determined by perceptual model (e.g., visibility model) for embedding locations across the signal. Another approach is to modulate the host so that it satisfies a robustness metric across the signal. Yet another is to modulate the host according to both the robustness metric and perceptual quality metric derived for each embedding location. The incorporated documents provide examples of these techniques. Below, we highlight a few examples.

For digital content including color images or color elements, the perceptual analyzer generates a perceptual model that evaluates visibility of an adjustment to the host by the embedder and sets levels of controls to govern the adjustment (e.g., levels of adjustment per color direction, and per masking region). This may include evaluating the visibility of adjustments of the color at an embedding location (e.g., units of noticeable perceptual difference in color direction in terms of CIE Lab values), Contrast Sensitivity Function (CSF), spatial masking model (e.g., using techniques described by Watson in US Published Patent Application No. US 2006-0165311 A1, which is incorporated by reference herein in its entirety), etc. One way to approach the constraints per embedding location is to combine the data with the host at embedding locations and then analyze the difference between the encoded host with the original. The rendering process may be modeled digitally to produce a modeled version of the embedded signal as it will appear when rendered. The perceptual model then specifies whether an adjustment is noticeable based on the difference between a visibility threshold function computed for an embedding location and the change due to embedding at that location. The embedder then can change or limit the amount of adjustment per embedding location to satisfy the visibility threshold function. Of course, there are various ways to compute adjustments that satisfy a visibility threshold, with different sequences of operations. See, e.g., U.S. application Ser. Nos. 14/616,686, 14/588,636 and 13/975,919, Patent Application Publication 20100150434, and U.S. Pat. No. 7,352,878.

The embedder also computes a robustness model in some embodiments. The computing a robustness model may include computing a detection metric for an embedding location or region of locations. The approach is to model how well the decoder will be able to recover the data signal at the location or region. This may include applying one or more decode operations and measurements of the decoded signal to determine how strong or reliable the extracted signal. Reliability and strength may be measured by comparing the extracted signal with the known data signal. Below, we detail several decode operations that are candidates for detection metrics within the embedder. One example is an extraction filter which exploits a differential relationship between a signal element and neighboring content to recover the data signal in the presence of noise and host signal interference. At this stage of encoding, the host interference is derivable by applying an extraction filter to the modulated host. The extraction filter models data signal extraction from the modulated host and assesses whether a detection metric is sufficient for reliable decoding. If not, the signal may be re-inserted with different embedding parameters so that the detection metric is satisfied for each region within the host digital content where the signal is applied.

Detection metrics may be evaluated such as by measuring signal strength as a measure of correlation between the modulated host and variable or fixed data components in regions of the host or measuring strength as a measure of correlation between output of an extraction filter and variable or fixed data components. Depending on the strength measure at a location or region, the embedder changes the amount and location of host signal alteration to improve the correlation measure. These changes may be particularly tailored so as to establish sufficient detection metrics for both the payload and synchronization components of the embedded signal within a particular region of the host digital content.

The robustness model may also model distortion expected to be incurred by the modulated host, apply the distortion to the modulated host, and repeat the above process of measuring visibility and detection metrics and adjusting the amount of alterations so that the data signal will withstand the distortion. See, e.g., U.S. Pat. No. 9,380,186, Ser. Nos. 14/588,636 and 13/975,919 for image related processing; each of these patent documents is hereby incorporated herein by reference.

This modulated host is then output as an output signal 162, with an embedded data channel. The operation of combining also may occur in the analog realm where the data signal is transformed to a rendered form, such as a layer of ink, including an overprint or under print, or a stamped, etched or engraved surface marking. In the case of video display, one example is a data signal that is combined as a graphic overlay to other video content on a video display by a display driver. Another example is a data signal that is overprinted as a layer of material, engraved in, or etched onto a substrate, where it may be mixed with other signals applied to the substrate by similar or other marking methods. In these cases, the embedder employs a predictive model of distortion and host signal interference and adjusts the data signal strength so that it will be recovered more reliably. The predictive modeling can be executed by a classifier that classifies types of noise sources or classes of host signals and adapts signal strength and configuration of the data pattern to be more reliable to the classes of noise sources and host signals.

The output 162 from the embedder signal typically incurs various forms of distortion through its distribution or use. This distortion is what necessitates robust encoding and complementary decoding operations to recover the data reliably.

Turning to FIG. 2, a signal decoder receives a suspect host signal 200 and operates on it with one or more processing stages to detect a data signal, synchronize it, and extract data. The detector is paired with input device in which a sensor or other form of signal receiver captures an analog form of the signal and an analog to digital converter converts it to a digital form for digital signal processing. Though aspects of the detector may be implemented as analog components, e.g., such as preprocessing filters that seek to isolate or amplify the data channel relative to noise, much of the signal decoder is implemented as digital signal processing modules.

The detector 202 is a module that detects presence of the embedded signal and other signaling layers. The incoming digital content is referred to as a suspect host because it may not have a data channel or may be so distorted as to render the data channel undetectable. The detector is in communication with a protocol selector 204 to get the protocols it uses to detect the data channel. It may be configured to detect multiple protocols, either by detecting a protocol in the suspect signal and/or inferring the protocol based on attributes of the host signal or other sensed context information. A portion of the data signal may have the purpose of indicating the protocol of another portion of the data signal. As such, the detector is shown as providing a protocol indicator signal back to the protocol selector 204.

The synchronizer module 206 synchronizes the incoming signal to enable data extraction. Synchronizing includes, for example, determining the distortion to the host signal and compensating for it. This process provides the location and arrangement of encoded data elements of a signal within digital content.

The data extractor module 208 gets this location and arrangement and the corresponding protocol and demodulates a data signal from the host. The location and arrangement provide the locations of encoded data elements. The extractor obtains estimates of the encoded data elements and performs a series of signal decoding operations.

As detailed in examples below and in the incorporated documents, the detector, synchronizer and data extractor may share common operations, and in some cases may be combined. For example, the detector and synchronizer may be combined, as initial detection of a portion of the data signal used for synchronization indicates presence of a candidate data signal, and determination of the synchronization of that candidate data signal provides synchronization parameters that enable the data extractor to apply extraction filters at the correct orientation, scale and start location. Similarly, data extraction filters used within data extractor may also be used to detect portions of the data signal within the detector or synchronizer modules. The decoder architecture may be designed with a data flow in which common operations are re-used iteratively, or may be organized in separate stages in pipelined digital logic circuits so that the host data flows efficiently through the pipeline of digital signal operations with minimal need to move partially processed versions of the host data to and from a shared memory, such as a RAM memory.

### Signal Generator

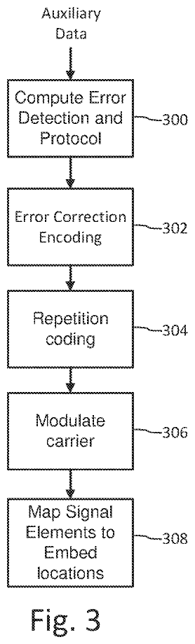

FIG. 3 is a flow diagram illustrating operations of a signal generator. Each of the blocks in the diagram depict processing modules that transform the input auxiliary data (e.g., the payload) into a data signal structure. For a given protocol, each block provides one or more processing stage options selected according to the protocol. In processing module 300, the auxiliary data is processed to compute error detection bits, e.g., such as a Cyclic Redundancy Check, Parity, or like error detection message symbols. Additional fixed and variable messages used in identifying the protocol and facilitating detection, such as synchronization signals may be added at this stage or subsequent stages.

Error correction encoding module 302 transforms the message symbols into an array of encoded message elements (e.g., binary or M-ary elements) using an error correction method. Examples include block codes, convolutional codes, etc.

Repetition encoding module 304 repeats the string of symbols from the prior stage to improve robustness. For example, certain message symbols may be repeated at the same or different rates by mapping them to multiple locations within a unit area of the data channel (e.g., one unit area being a tile of bit cells, bumps or “waxels,” as described further below).

Next, carrier modulation module 306 takes message elements of the previous stage and modulates them onto corresponding carrier signals. For example, a carrier might be an array of pseudorandom signal elements. The data elements of an embedded signal may also be multi-valued. In this case, M-ary or multi-valued encoding is possible at each signal element, through use of different colors, ink quantity, dot patterns or shapes. Signal application is not confined to lightening or darkening an object at a signal element location (e.g., luminance or brightness change). Various adjustments may be made to effect a change in an optical property, like luminance. These include modulating thickness of a layer, surface shape (surface depression or peak), translucency of a layer, etc. Other optical properties may be modified to represent the signal element, such as chromaticity shift, change in reflectance angle, polarization angle, or other forms optical variation. As noted, limiting factors include both the limits of the marking or rendering technology and ability of a capture device to detect changes in optical properties encoded in the signal. We elaborate further on signal configurations below.

Mapping module 308 maps signal elements of each modulated carrier signal to locations within the channel. In the case where a digital host signal is provided, the locations correspond to embedding locations within the host signal. The embedding locations may be in one or more coordinate system domains in which the host signal is represented within a memory of the signal encoder. The locations may correspond to regions in a spatial domain, temporal domain, frequency domain, or some other transform domain. Stated another way, the locations may correspond to a vector of host signal features at which the signal element is inserted.

Various detailed examples of protocols and processing stages of these protocols are provided in, e.g., U.S. Pat. Nos. 6,614,914, 5,862,260, 6,345,104, 6,993,152 and 7,340,076, which are hereby incorporated by reference in their entirety, and US Patent Publication 20100150434, previously incorporated. More background on signaling protocols, and schemes for managing compatibility among protocols, is provided in U.S. Pat. No. 7,412,072, which is hereby incorporated by reference in its entirety.

The above description of signal generator module options demonstrates that the form of the signal used to convey the auxiliary data varies with the needs of the application. As introduced at the beginning of this document, signal design involves a balancing of required robustness, data capacity, and perceptual quality. It also involves addressing many other design considerations, including compatibility, print constraints, scanner constraints, etc. We now turn to examine signal generation schemes, and in particular, schemes that employ signaling, and schemes for facilitating detection, synchronization and data extraction of a data signal in a host channel.

One signaling approach, which is detailed in U.S. Pat. Nos. 6,614,914, and 5,862,260, is to map signal elements to pseudo-random locations within a channel defined by a domain of a host signal. See, e.g., FIG. 9 of 6,614,914. In particular, elements of a watermark signal are assigned to pseudo-random embedding locations within an arrangement of sub-blocks within a block (referred to as a “tile”). The elements of this watermark signal correspond to error correction coded bits output from an implementation of stage 304 of FIG. 3. These bits are modulated onto a pseudo-random carrier to produce watermark signal elements (block 306 of FIG. 3), which in turn, are assigned to the pseudorandom embedding locations within the sub-blocks (block 308 of FIG. 3). An embedder module modulates this signal onto a host signal by adjusting host signal values at these locations for each error correction coded bit according to the values of the corresponding elements of the modulated carrier signal for that bit.

The signal decoder estimates each coded bit by accumulating evidence across the pseudo-random locations obtained after non-linear filtering a suspect host digital content. Estimates of coded bits at the signal element level are obtained by applying an extraction filter that estimates the signal element at particular embedding location or region. The estimates are aggregated through de-modulating the carrier signal, performing error correction decoding, and then reconstructing the payload, which is validated with error detection.

This pseudo-random arrangement spreads the data signal such that it has a uniform spectrum across the tile. However, this uniform spectrum may not be the best choice from a signal communication perspective since energy of a host digital content may concentrated around DC. Similarly, an auxiliary data channel in high frequency components tends to be more disturbed by blur or other low pass filtering type distortion than other frequency components. A variety of signal arrangements are detailed in U.S. patent application Ser. No. 14/724,729 (now U.S. Pat. No. 9,747,656), which are each hereby incorporated by reference in its entirety. This application details several signaling strategies that may be leveraged in the design of encoded signals, in conjunction with the techniques in this document. Differential encoding applies to signal elements by encoding in the differential relationship between a signal element and other signals, such as a background, host elements, or other signal components (e.g., a sync component).

U.S. Pat. No. 6,345,104, building on the disclosure of U.S. Pat. No. 5,862,260, describes that an embedding location may be modulated by inserting ink droplets at the location to decrease luminance at the region, or modulating thickness or presence of line art. Additionally, increases in luminance may be made by removing ink or applying a lighter ink relative to neighboring ink. It also teaches that a synchronization pattern may act as a carrier pattern for variable data elements of a message payload. The synchronization component may be a visible design, within which a sparse data signal (see, e.g., U.S. Pat. No. 11,062,108) or dense data signal is merged. Also, the synchronization component may be designed to be imperceptible, using the methodology disclosed in U.S. Pat. No. 5,862,260.

We further discuss the design, encoding and decoding of signals in more detail. As introduced above, one consideration in the design of an encoded signal is the allocation of signal for data carrying and for synchronization. Another consideration is compatibility with other signaling schemes in terms of both encoder and decoder processing flow. With respect to the encoder, the encoder should be compatible with various signaling schemes, including dense and sparse signaling, so that it each signaling scheme may be adaptively applied to different regions of a digital content design, as represented in a digital content, according to the characteristics of those regions. This adaptive approach enables the user of the encoder tool to select different methods for different regions and/or the encoder tool to be programmed to select automatically a signaling strategy that will provide the most robust signal, yet maintain the highest quality image, for the different regions.

One example of the advantage of this adaptive approach is in a design that has different regions requiring different encoding strategies. One region may be blank, another blank with text, another with a graphic in solid tones, another with a particular spot color, and another with variable image content.

With respect to the decoder, this approach simplifies decoder deployment, as a common decoder can be deployed that decodes various types of data signals, including both dense and sparse signals.

As introduced above with reference to FIG. 3, there are stages of modulation/de-modulation in the encoder, so it is instructive to clarify different types of modulation. One stage is where a data symbol is modulated onto an intermediate carrier signal. Another stage is where that modulated carrier is inserted into the host by modulating elements of the host. In the first case, the carrier might be pattern, e.g., a pattern in a spatial domain or a transform domain (e.g., frequency domain). The carrier may be modulated in amplitude, phase, frequency, etc. The carrier may be, as noted, a pseudorandom string of 1's and 0's or multi-valued elements that is inverted or not (e.g., XOR, or flipped in sign) to carry a payload or sync symbol.

As noted in U.S. patent application Ser. No. 14/724,729, carrier signals may have structures that facilitate both synchronization and variable data carrying capacity. Both functions may be encoded by arranging signal elements in a host channel so that the data is encoded in the relationship among signal elements in the host. Application Ser. No. 14/724,729 specifically elaborates on a technique for modulating, called differential modulation. In differential modulation, data is modulated into the differential relationship among elements of the signal. In some watermarking implementations, this differential relationship is particularly advantageous because the differential relationship enables the decoder to minimize interference of the host signal by computing differences among differentially encoded elements. In sparse data signaling, there may be little host interference to begin with, as the host signal may lack information at the embedding location.

Another form of modulating data is through selection of different carrier signals to carry distinct data symbols. One such example is a set of frequency domain peaks (e.g., impulses in the Fourier magnitude domain of the signal) or sine waves. In such an arrangement, each set carries a message symbol. Variable data is encoded by inserting several sets of signal components corresponding to the data symbols to be encoded. The decoder extracts the message by correlating with different carrier signals or filtering the received signal with filter banks corresponding to each message carrier to ascertain which sets of message symbols are encoded at embedding locations.

Having now illustrated methods to modulate data into the watermark (either dense or sparse), we now turn to the issue of designing for synchronization. For the sake of explanation, we categorize synchronization as explicit or implicit. An explicit synchronization signal is one where the signal is distinct from a data signal and designed to facilitate synchronization. Signals formed from a pattern of impulse functions, frequency domain peaks or sine waves is one such example. An implicit synchronization signal is one that is inherent in the structure of the data signal.

An implicit synchronization signal may be formed by arrangement of a data signal. For example, in one encoding protocol, the signal generator repeats the pattern of bit cells representing a data element. We sometimes refer to repetition of a bit cell pattern as “tiling” as it connotes a contiguous repetition of elemental blocks adjacent to each other along at least one dimension in a coordinate system of an embedding domain. The repetition of a pattern of data tiles or patterns of data across tiles (e.g., the patterning of bit cells in U.S. Pat. No. 5,862,260) create structure in a transform domain that forms a synchronization template. For example, redundant patterns can create peaks in a frequency domain or autocorrelation domain, or some other transform domain, and those peaks constitute a template for registration. See, for example, U.S. Pat. No. 7,152,021, which is hereby incorporated by reference in its entirety.

The concepts of explicit and implicit signaling readily merge as both techniques may be included in a design, and ultimately, both provide an expected signal structure that the signal decoder detects to determine geometric distortion.

In one arrangement for synchronization, the synchronization signal forms a carrier for variable data. In such arrangement, the synchronization signal is modulated with variable data. Examples include sync patterns modulated with data.

Conversely, in another arrangement, that modulated data signal is arranged to form a synchronization signal. Examples include repetition of bit cell patterns or tiles.

The variable data and sync components of the encoded signal may be chosen so as to be conveyed through orthogonal vectors. This approach limits interference between data carrying elements and sync components. In such an arrangement, the decoder correlates the received signal with the orthogonal sync component to detect the signal and determine the geometric distortion. The sync component is then filtered out. Next, the data carrying elements are sampled, e.g., by correlating with the orthogonal data carrier or filtering with a filter adapted to extract data elements from the orthogonal data carrier. Signal encoding and decoding, including decoder strategies employing correlation and filtering are described in U.S. patent application Ser. No. 14/724,729.

Additional examples of explicit and implicit synchronization signals are provided in previously cited U.S. Pat. Nos. 6,614,914, and 5,862,260. In particular, one example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference in its entirety.

US Publication No. 20120078989, which is hereby incorporated by reference in its entirety, provides additional methods for detecting an embedded signal with this type of structure and recovering rotation, scale and translation from these methods.

Additional examples of implicit synchronization signals, and their use, are provided in U.S. Pat. Nos. 9,747,656, 7,072,490, 6,625,297, 6,614,914, and 5,862,260, which are hereby incorporated by reference in their entirety.

### II. Digital Watermarking for Proof of NFT Authenticity

Unlike coins in crypto currencies, non-fungible tokens (“NFTs”) are blockchain tokens designed to be unique and non-fungible. This means that a first NFT token is uniquely distinguished from a second NFT, and a third NFT, and so on. NFTs are often implemented according to a standard, e.g., the ERC721 standard, which allows an NFT to be owned by a single owner at any given time and allows secure transfer from one owner to another. For example, the ERC721 standard provides an application programming interface (API) allowing computer programs to connect with each other. With this standard, it is possible to trace all transactions associated with an NFT, from its transfer between owners to its current value on the market. Another NFT standard is the ERC1155 standard, which allows for creation and transfer of multiple tokens at the same time. As mentioned above, we use the term “digital content” to mean one or more digital assets associated with an NFT. Examples of digital assets include images and pictures, digital art, digital images generated by Artificial Intelligence (“AI”), graphics, logos, digital designs, 3D models, documents and presentations, video (including one or more video frames), audio, metaverse assets, etc. An NFT typically includes associated metadata. For this patent document NFT metadata includes associated data such as a document (e.g., JSON document) or file containing elements. Here is an example of an NFT metadata document:
{“name”:“Grumpy Cat”,“description”:“We present this original remastered Grumpy Cat photographic image. This singular keepsake is available as a 1/1 authenticated edition NFT.\n\nArguably the planet's most famous feline, Grumpy Cat is a New York Times best selling author, the star of her own Lifetime Christmas movie, and the first cat in history to be honored with a Madame Tussaud's wax figure. Grumpy became a pop cultural icon on Sep. 23, 2012, after her frowning photo was posted to Reddit.\n\n1626×1957 pixels.\n\nBest NFT Ever.”,“image”:“ipfs://ipfs/QmfWtxAM2qwKrEXVoeasArDBrR12qL7HCuD2B4Tqe5R 8Bs/nft.jpg” }

Due to their non-fungibility, NFTs are often used in combination with digital content in the metaverse or video games. However, while an NFT is guaranteed to be unique, the link between an NFT and its associated digital content is cryptographically weak. This technical problem allows for someone to simply copy the digital content (“DC1”) attached to an NFT (“NFT1”) and create a new NFT (“NFT2”) attached to the same digital content (i.e., the same “DC1”). Thus, there could be two NFTs (NFT1 and NFT2) linked to the same digital content (DC1).

For popular NFT collections, e.g., Bored Apes—https://opensea.io/collection/boredapeyachtclub) this weak link is an issue, but it can be mitigated somewhat by ensuring that an NFT is minted via the well-known Bored Apes smart contract. However, for the vast majority of users and NFTs this weak link is an acute issue that can lead to fraud and counterfeits. Current solutions to this counterfeiting problem involve manual authentication (“Proof of Democracy”) of digital content bound to NFTs, see, e.g., https://wakweli.com/.

One aspect of our described technology provides a cryptographical way of irreversibly linking an NFT with its digital content. This protects digital content bound to NFTs by using a digital watermark that only the creator of the digital content could have generated or authorized. In a first embodiment, a Creator creates digital content and then creates a cryptographic binding between: i) the digital content, ii) the blockchain used for minting, and iii) the creator.

Our implementations are provided below in steps 1-7:
1. Creator creates digital content.
2. Creator mints an NFT on blockchain “B” via smart contract “C”. A creator wallet (e.g., Metamask) is connected to an NFT marketplace (e.g., OpenSea). The creator wallet issues a transaction to the NFT smart contract connected to the marketplace. Typically, a wallet is used to pay a fee for the smart contract execution. The smart contract then returns a unique identifier (e.g., “tokenId” in the below minting function) that will be bound in the NFT metadata. An example minting function is provided below:

```
function mintNFT(address recipient, string memory tokenURI)
  public onlyOwner
  returns (uint256)
{
  _tokenIds.increment( );
  uint256 newItemId =_tokenIds.current( );
  _mint(recipient, newItemId);
  _setTokenURI(newItemId, tokenURI);
  return newItemId;
}
```

### Where:

a. “recipient” is the wallet's public address that will receive the minted NFT;
b. “tokenURI” is a string resolving to a document (e.g., JSON) describing the NFT's metadata; and
c. “newItemId” is the unique identifier of the newly minted NFT.
3. Creator creates a signed message of the digital content that can be used to cryptographically tie back the digital content to the creator, the NFT, the blockchain and the smart contract that created (minted) the NFT. Here is an example of such a signed message in JSON format:

{
“blockchain”: “ethereum”,
“contractAddress”: “0x81a02b72089378190b5ecec992986d1c3b178252”,
“tokenId”: 12,
“contentHash”:
“ab4ee979669fc6316da0689c6339c7a99a80a67bc78401378db19da4b3968bf3”,
“signature”:
“0x21fbf0696d5e0aa2ef41a2b4ffb623bcaf070461d61cf7251c74161f82fec3a4370854bc0
a34b3ab487c1bc021cd318c734c51ae29374f2beb0e6f2dd49b4bf41c”
}

### Where:

a. “blockchain” is the blockchain used to mint the NFT (here, Ethereum), this could also be used as an identifier (or DLT Identification) of the blockchain;
b. “contractAddress” is the address of the smart contract used to mint the NFT;
c. “tokenId” is the actual NFT ID (here, “12”) returned by the smart contract;
d. “contentHash” is a perceptual, image-based or other hash of the digital content prior to digital watermark insertion; and
e. “signature” is the content of the JSON message (contentHash, blockchain, contractAddress, tokenId) signed with a private key of the creator.
   In one embodiment this message is added to or referenced by the NFT metadata. Fields “blockchain” and “contractAddress” help ensure that the creator cannot mint the NFT corresponding to the digital content on several blockchains and or via several smart contracts. This and field “tokenID” uniquely tie the tokenID to the selected blockchain and smart contract. Field “contentHash” adds an additional layer of security that the digital watermark has not been placed in the wrong artwork. Field “signature” ensures only the creator (owner of the private key) has signed the message. The private key is preferably generated using an asymmetric public-private cryptographic schemes, e.g., one based on Elliptic-Curve Cryptography of ECC or Rivest-Shamir-Adleman (RSA). For example, an Elliptic Curve Digital Signature Algorithm (ECDSA) uses ECC keys to ensure each user is unique. Other signing algorithms include, e.g., the Schnorr signature and the BLS (Boneh-Lynn-Shacham) signature. SECP, or SECP256k1 in particular, is the name of an elliptic curve. Examples of SECP include the Elliptic Curve Digital Signature Algorithm (ECDSA) and Schnorr signatures mentioned above. ECDSA and Schnorr signature algorithms work with the SECP256k1 curve in many blockchains.
4. The signed message (e.g., the signature) is hashed using a cryptographic hash function such as, e.g., SHA-1, SHA-2, SHA-3, MD5, NTLM, Whirlpool, BLAKE2, BLAKE3 or LANMAN 8, yielding, for example: 41d0b2c646c49a42b3f678b869dc2b72089378190b5ecec992986d1c3b178252, and the hash is embedded within the digital content as a digital watermark payload. Suitable digital watermark embedding is discussed above in Section I, and within the incorporated by reference patent documents. (In an alternative embodiment, two digital watermarks are used in step 4. A first digital watermark identifies a smart contract broker (or NFT network). This digital watermark may be embedded using a public encoder, meaning decoding access is widely available for public use. A second digital watermark carries a cryptographic hash of the signed message. The second digital watermark can be embedded using a more restricted embedder, e.g., one with a spreading or encoding key that corresponds to a restricted detector. The restricted detector includes a corresponding key that enables the detector to locate and/or decode the cryptographic hash. This is useful to allow the smart contract broker to restricted distribution of a restricted decoder to users directed to them via the first digital watermark.)
5. Digital content is uploaded to the URI referenced in the URI metadata.
6. Creator adds (e.g., lists for sale) the NFT to a marketplace (e.g., OpenSea).
7. A potential purchaser can verify the authenticity and uniqueness of the NFT and associated digital content by decoding the digital watermark and comparing it with a hash of the relevant JSON fields referenced or included in the NFT metadata. Suitable digital watermark decoding is discussed above in Section I, and within the incorporated by reference patent documents.
8. Purchaser buys the NFT and transfers ownership (ownership transfer authorized by Creator), for example, using the following transfer function:
function transfer(address indexed_from, address indexed_to, uint256 indexed newItemId).

For verification, e.g., a user of a NFT marketplace or social network using NFTs, provides the watermarked digital content to a corresponding digital watermarking decoder. The decoder locates and decodes the digital watermarking to obtain the payload (e.g., comprising the cryptographic hash as in no. 4, above). This decoded, cryptographic hash value can then be compared with a corresponding hashing of the relevant NFT “metadata” fields (e.g., contentHash, blockchain, contractAddress, tokenId).

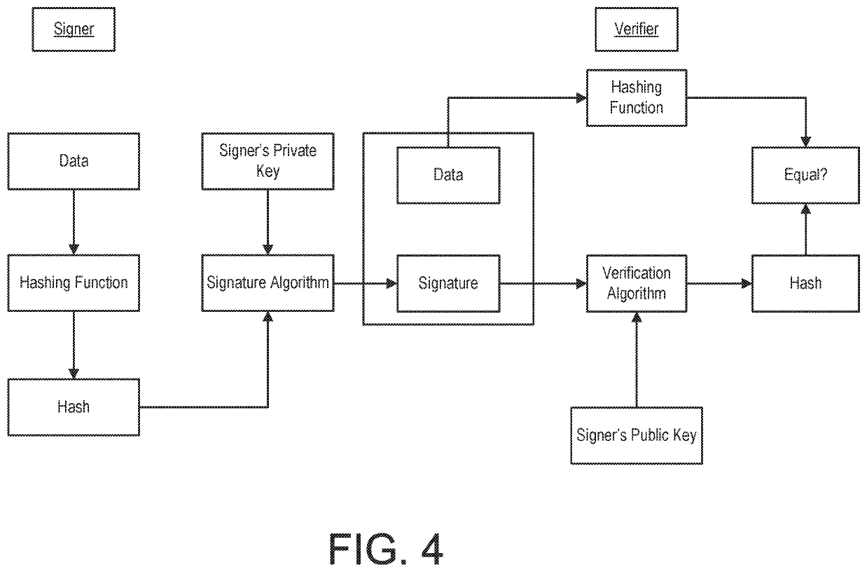

To verify private key-based signatures, a mapping between creators and their addresses can be maintained by a NFT network or pointed to within NFT metadata. To verify a signature one needs the corresponding public key, or address of the signer, here the creator. For example, and with reference to FIG. 4, steps for secure signing including the following:
A sender creates a message digest using a cryptographic hash function. This message digest is a condensed or reduced-bit version of data that is unique to that specific NFT.
The sender uses her private key to sign the message digest, producing a digital signature. This digital signature is unique to the combination of the private key and the message digest.
The sender then sends the NFT, along with the digital signature, to the recipient. Here, the recipient can be an NFT network or social media platform.
The recipient uses the sender's public key, which is publicly available, to verify the digital signature. If the signature is valid, it indicates that the transaction data has not been altered in any way and that it was indeed sent by the owner of the private key.

One example of a creator signature is a message including a string of alphanumeric symbols, such as “I am authenticating myself as Creator XXX to use Digital Watermarking for NFT Tools”. And then, the creator or artist posts this signed message on one or several social networks (e.g., X, formerly Twitter). An alternative implementation uses DIDs—Decentralized Identifiers—to identify creators and their public keys.

Digital watermarking also can be used to show transfer of ownership using a series of chained watermarks, one for each person in the chain. Consider the following implementations:
1. After digital content is minted and digital watermarked to carry cryptographic information as discussed above (e.g., hash as in no. 4, above), the watermarked digital content, along with associated metadata, can be stored in the Interplanetary File System (or “IPFS”). This is an initial version of digital content, or “version 0”, which is analogous to a Vehicle Identification Number or VIN in a car analogy. Anyone accessing the IPFS can see the digital content. (The IPFS is a file sharing system that can be leveraged to efficiently store and share large files. It relies on cryptographic hashes that can easily be stored on a blockchain. Storing metadata here provides frozen metadata, since alteration of the original metadata can be easily detected via cryptographic measures.)
2. As part of a transfer of ownership of an NFT, e.g., a first sale of the digital content, version 0 of the digital content is digitally watermarked. This is a second digital watermarking of the digital content since the creator already marked version 0. This second digital watermarking includes a signature created with the first owner's Private Key, and perhaps transaction details. This would be like adding new license plate on the car. Just like in our car example, the VIN hasn't changed, but the registered owner is reflected with the addition of new plates.
3. The resulting digital content now contains two digital watermarks: the Creator's and the registered owner at the time of the initial transfer of ownership.
4. Upon a resale, the digital content is again digital watermarked. This is a third digital watermarking of the digital content since the creator and first purchaser already marked the digital content. This third digital watermarking includes a signature created with the second owner's Private Key, and perhaps transaction details. The third digital watermark may not necessarily decide who owns the work, as there may be additional watermark layers, but as the whole ownership history is included in layered digital watermarks, all registered watermarks can be evaluated to whomever determine the current registrant.

This allows having the chain of ownership verifiable directly from the content of the watermark. This can be useful for traitor-tracing and licensing models where media is licensed by narrow fields of use, etc. (production music, stock photo agencies, etc.)

Consider another implementation where a digital watermark payload is added or updated to reflect a chain of ownership. A creator creates a signature using her private key: s1=sign(smart contract address+target blockchain, privateKey). This creator signature represents at least a smart contract address and target blockchain signed with the creator's private key. The signature may include additional data, e.g., NFT identifier, perceptual hash or fingerprint of the digital content, creator information, public key information, etc. S1 is embedded in digital content as a first payload with first digital watermarking. A subsequent owner (e.g., a first purchase of the digital content) creates a second signature with their private key: s2=sign(s1, privateKey). This S2 is then embedded into the digital content with digital watermarking. S2 can be embedded into the digital content using a second digital watermark which is layered with the first digital watermark, e.g., using different protocols or different spreading keys; however, S2 could replace S1 if using so-called reversible digital watermarking. That is, S1 (and the digital watermark carrying such) is removed from the digital content, and the S2 is then embedded. So, if using reversible digital watermarking, the digital content only has 1 digital watermark, carrying S2. A cryptographic link with S1 still survives, however, since the S2 signature utilizes S1+the first buyer's private key. A subsequent owner can then create a signature with their private key: s3=sign(s2, privateKey). Like above, S3 could be layered into the digital content, which would include three different digital watermarks, respectively carrying S1, S2 and S3. Or, if using reversible digital watermarking, S2 could be removed, and replaced with a digital watermark carrying just S3 as a payload. This methodology allows having the chain of ownership verifiable directly from the content of the watermark. Examples of reversible digital watermarking are described, e.g., in U.S. Pat. Nos. 8,098,883, 8,059,815, 8,032,758, 7,187,780, and in published PCT Application No. WO2004102464A3, each of which is hereby incorporated herein by reference in its entirety.

In a related implementation, a watermark embedder to handle the above embedding is only available from an address associated with data carried by or accessed via a smart contract. This creates a contractual lock on who and under what conditions a digital watermark can be embedded into the digital content. This approach may also require the current version of the digital content from a digital content broker associated with a sale, e.g., to watermark for a first or second buyer. The digital watermark embedder preferably includes or communicates with a digital watermark decoder that is capable of reading a previous digital watermark from the current version to retrieve S1 or S2. This decoder check ensures that S1 or S2 is present in the digital content before launching in to embed S2 or S3, depending on the sale status. This contractual embedder access and checking of a previous signature helps prevent spoofed attempts to “overwrite” the watermark with a spoofed signature payload.

For an asset that has been traded significantly (e.g., in-game artwork, etc.) or has fractional ownership via an NFT, the same digital watermark infrastructure as above (starting with unmarked content) could be applied but each time a new fractional owner is added, an update to a Merkle Tree can be made, allowing to confirm the provenance of the item (who all the owners were/are).

Now consider some additional digital watermarking implementations, including one that uses two (2) different types of digital watermarks embedded within the same digital content.
Digital watermark 1: Digital watermark 1 only includes a synchronization component, as described above in Section I and in the incorporated by reference patent documents, without a message signal. This is essentially a 1-bit digital watermark as determined by the presence or not of the synchronization component. The bit carrying capacity of a synchronization signal only watermark can be expanded, however, by varying the alignment or start location (or start location) of the signal relative to the digital content. Say, for example, that the synchronization signal is aligned to the top corner of an image. This is translation position 00. If translation of the synchronization component is shifted from the top left corner of the image, oh say to the top right corner of the image, then this is position 01 (10=bottom right, 11=bottom left). The translation or orientation of the synchronization signal relative to the digital content now carries information. Of course, subtle shifts and offsets can be used as a signal origin instead of image corners. In an extreme case, the synchronization component is aligned within digital content according to 128×128 shift positions, or 16 K of address space. In a less extreme case, only 64×64 translation positions, or 4 K of address space. This allows a digital watermark to convey a relatively small address space meant to indicate, e.g., the NFT marketplace, smart contract broker or target blockchain.
Digital watermark 2: Digital watermark 2 only includes a message component, which is intended to be aligned with the synchronization component of a digital watermark 1. Using digital watermark 2 is useful in a case, e.g., where a widely distributed low-resolution version digital content points potential buyers back to the NFT marketplace, smart contract broker or target blockchain, via digital watermark 1. The NFT marketplace or smart contract broker can provide a high-resolution version of the low-resolution digital content (preferably including digital watermark 1) for sale.
Upon a sale of the high-resolution digital content, digital watermark 2 can be embedded within the digital content, with the embedding aligned with the synchronization component carried by digital watermark 1. Digital watermark 2 preferably includes a plural-bit payload (e.g., including creator information or the chain of owners discussed above).

Using such a digital watermark-based approach, an NFT marketplace (e.g., OpenSca) can make all digital content that is widely available, but with only digital watermark 1 embedded in the digital content. Digital watermark 1's synchronization component, referenced in the digital content at a particular origin (e.g., middle, or top-right corner) indicates that the NFT marketplace is the broker. A perceptual or image-based hash can also be written to a blockchain in some form at the time the creator signs up with NFT marketplace. Instead of a low-resolution version as discussed above, now consider a high-resolution version of the digital content embedded with digital watermark 1 set free on the Internet. There are now three possible actions occurring upon encountering the watermark digital content:
a. If no digital watermark 1 is detected using a digital watermark reader, well, proceed as business as usual with this digital content.
b. If the watermark reader decodes digital watermark 1, the digital content is possibly for sale. The reader is programed to compare the translation or origin of the synchronization signal to determine which NFT marketplace is hosting the digital content.
c. If the watermark reader decodes digital watermark 2, you now know who the current owner is and what the rights are associated with it via the smart contract. Reviewing the smart contract may yield a happy surprise, e.g., it allows you to print a T-Shirt at no cost, but no other uses are allowed.

At ingest of popular content sites, a digital watermark detector can be employed as a filter that looks for digital watermark 1 and/or digital watermark 2, upon digital content upload. Once a digital watermark is found, action can be taken. The benefit of using digital watermark 2 with smart contracts is that licensing can be automated anywhere the image goes if the contract allows, not only through sale of an asset via a broker. This allows for tracking and tracing the digital content, and collecting fees upon encountering the digital content. An associated smart contract can be referenced upon finding digital watermark 2 to ascertain proper use of the digital content. For example, the smart contract may indicate whether digital content is licensed for a specific region, or network site. In an extreme example, using a so-called “white-list” construct, if the digital content is found anywhere not included on the white-list (e.g., carried by the smart contract), an automated take-down request is generated.

In some embodiments, information intended to be included in a digital watermark (e.g., a tokenID) might not necessarily be known prior to minting an NFT. Once an NFT is minted, however, all the data (including the digital content) is preferably frozen and, hence, cannot be modified. Consider the following examples.

For chain watermarking, digital watermarks can be added to digital content by a smart contract code itself. In this embodiment, a watermark embedder is included in smart contract code so that the smart contract can add digital watermarks to NFT digital content as part of the minting process (or right after).

In another embodiment, NFT metadata includes only an NFT token ID (“tokenID”), the smart contract address and the blockchain identifier. In most cases the token ID can be predicted via auditing of the smart contract, but this is not always possible, e.g., in the case of non-sequential token IDs or when facing race conditions. In related embodiments, if we know the smart contract address, but we can't predict the token ID, the token ID could be replaced by the address of the minter (e.g., the digital content creator) and the transaction nonce. A transaction nonce is a value (usually numerical) that is included in a transaction and is used to prevent replay attacks. The value can be incremented each time a transaction is sent by a particular blockchain account or wallet. When encoding this information, verifying whether an NFT is authentic could be slightly different. Indeed, from the contract address, chain ID and token ID, that we already have, we retrieve the address of the minter and the transaction nonce. To do so, we find the transaction where this particular token ID was minted on this particular contract address.

Similarly, the contract address might not be known because the digital content is already baked into (e.g., included with) the contract prior to deployment when the address is assigned. In this case, the contract address could be replaced by the artist address (the address which deploys the smart contract) as well as the transaction nonce. When encoding this information, verifying whether an NFT is authentic will be slightly different. Indeed, from the contract address, chain ID and token ID, that we already have, we retrieve the address of the minter and the transaction nonce. To do so, we find the transaction where this particular token ID was minted on this particular contract address. From that, we can get the minter and the transaction nonce. A flag (e.g., one or more bits) can be used to distinguish which version of NFT metadata is used. This is helpful when wanting to protect digital content within an NFT collection linked to a smart contract that is going to be deployed. Typically, a link is included for such images in a smart contract before deployment.

In another embodiment, we leverage a concept called “lazy minting.” Lazy minting generally means that the NFT isn't minted when its created, but rather when the NFT sells. However, once created, an NFT marketplace (e.g., Opensea) already provides a reserved token ID (and reserved contract address), which means we can know such before minting. A solution utilizing lazy minting creates an NFT without frozen NFT metadata, copies its token ID, blockchain identifier and contract address, embeds this information in associated digital content using digital watermarking, updates the image of the NFT, and then freezes the metadata (e.g., using an IPFS URI). This could be implemented using web extensions and/or an API.

Hashing an NFT metadata file and embedding such in a digital watermark is a first option as discussed above. A second option is to store this metadata in a manifest file attached to the digital content (e.g., via an EXIF header in the case of a JPEG image), e.g., by extending a standard manifest format such as C2PA Content Credentials. Then, a digital watermark can contain a hash of this manifest. A third option is to include the entire or full NFT metadata as a digital watermark payload. In related cases (or optional cases) the entire or full NFT metadata is signed with private key. In this related case, for digital content found on the internet, one would know if it were linked to an NFT. That is, a digital watermark detector analyzes the found digital content to retrieve encoded data. The encoded data may include the full NFT metadata. This scenario avoids reconstructing NFT metadata and corresponding hash (first option) to know if an NFT is an original or re-mint.

A fourth option is to host a non-hashed version of the NFT metadata file in a decentralized file system (e.g., IPFS), copy the file ID or full IPFS Web URI (e.g., ipfs://bafybeigdyrzt5sfp7udm7hu76uh7y26nf3efuylqabf3oclgtqy55fbzdi), and encode it (file ID or full IPFS Web URI) into the digital content as a digital watermark payload. (As mentioned above, the IPFS is a file sharing system that can be leveraged to efficiently store and share large files. It relies on cryptographic hashes that can be stored on a blockchain. Storing metadata here provides “frozen” metadata, since alteration of the original metadata can be easily detected via cryptographic measures.) Once decoded from a digital watermark embedded in digital content, the file ID or IPFS web URI is utilized to access the frozen non-hashed version of the NFT metadata file. In some implementations, the first n-number of bits or last n-number of bits (where n is a positive integer) of a digital watermark payload can be reserved for identifying which decentralized file system is used, and then at least some of the remaining bits would be the file ID. Or we could encode the decentralized URI in the digitally watermarked digital content as a digital watermark payload. If someone finds the digital content somewhere without any context, they could open their digital watermark decoding app (e.g., Digimarc Discover, provided by Digimarc Corporation, with offices in Beaverton, Oregon USA), scan the digital content (e.g., an image, graphic or video), and they would be redirected to an NFT marketplace with the NFT associated with the digital content. Regarding identifying bits, in one embodiment, a record is defined which uniquely and authoritatively maps blockchains to a code (or DLT identifiers/identification) in the NFT metadata file. For the EVM (ethereum virtual machine) compatible chains, we would use their chain IDs which is a common practice (the list of chain IDs is available on chainlist.org). For other chains, codes could be established. Here is an example:

| Blockchain | Code |
|---|---|
| Ethereum | 1 |
| Bitcoin | BTC |
| Polygon | 137 |
| Solana | SOL |
| Optimism | 10 |

Now consider contextual redirections for NFTs. It is a somewhat common practice for people to post a new NFT on their social media networks, e.g., using the NFT's digital content as their social network profile image. A user wanting to access or test the validity of the displayed NFT could open a digital watermark detector (e.g., the Digimarc Discover app running on an iPhone or Android smartphone) and capture imagery representing the digital content. The watermark detector analyzes the captured digital content (e.g., imagery, graphics or video) to locate and decode the digital watermark embedded therein. The digital watermark my include or link to an NFT exchange such as OpenSea (or equivalent), which provides detailed information such as NFT cost, attributes, and creator of the NFT. Additionally, the digital watermark can be used to determine validity of the NFT.

Relatedly, an artist can log in to a platform and configure where to redirect people based on the context (e.g., redirect them to a new piece of art which will be in an auction starting in the future, e.g., 2 days from now). In this case, a digital watermark detector, e.g., running on a smartphone, directs the user to the platform. The decoded tokenID can be used to access an associated NFT data record stored on the platform, which contains the redirection link provided by the artist. The redirection link is communicated from the platform to, e.g., a smartphone-based digital watermark detector. The redirection link is provided to a web browser hosted by the smartphone, which connects to the redirection link. Redirection can also be based on location. For example, the data record has a redirection link to direct everyone from the US to a first website, e.g., to auction physical art. Alternatively, users could use a browser extension to automatically see the NFT redirection and well as its authenticity.

In additional to including or linking to NFT metadata, a digital watermark may include or link to license, ownership and copyright information associated with the NFT.

Our technological solutions are also applicable to so-called dynamic NFT (dNFT), which are Non-Fungible Tokens (NFT) with encoded smart contract logic that enables it to automatically change its metadata based on external conditions. In some cases, the underlying digital content itself is dynamically changed. The original digital watermark could be replaced, but in one embodiment a second digital watermark can be added to the changed digital content. The second digital watermark preferably includes a tie or link (e.g., cryptographic link) between the original digital content (e.g., a hash of such) or first digital watermark (or hash of such) and the changed digital content or second digital watermark.

Upon resale of a NFT, a technical mechanism can be established to help funnel a royalty payment back to the original creator. The creator originally maintains a listing or record of all digital watermark hashes and corresponding artist address for her NFTs. Such a listing or record could be included within the smart contract itself. Upon a resale, the digital watermark hash from the resale digital content is checked against the listing or record. If it is found, the system diverts a portion of sale proceeds to the artist address to cover the royalty. Of course, instead of including the record or listing in the smart contract, the mappings could be centralized. This would allow artists to earn royalties when someone sells a copy of their NFT.

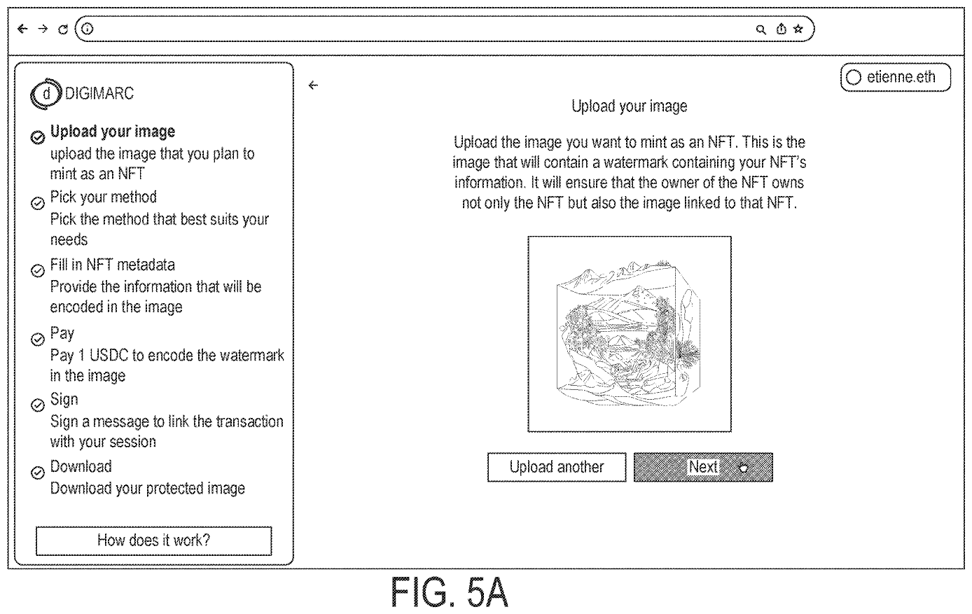

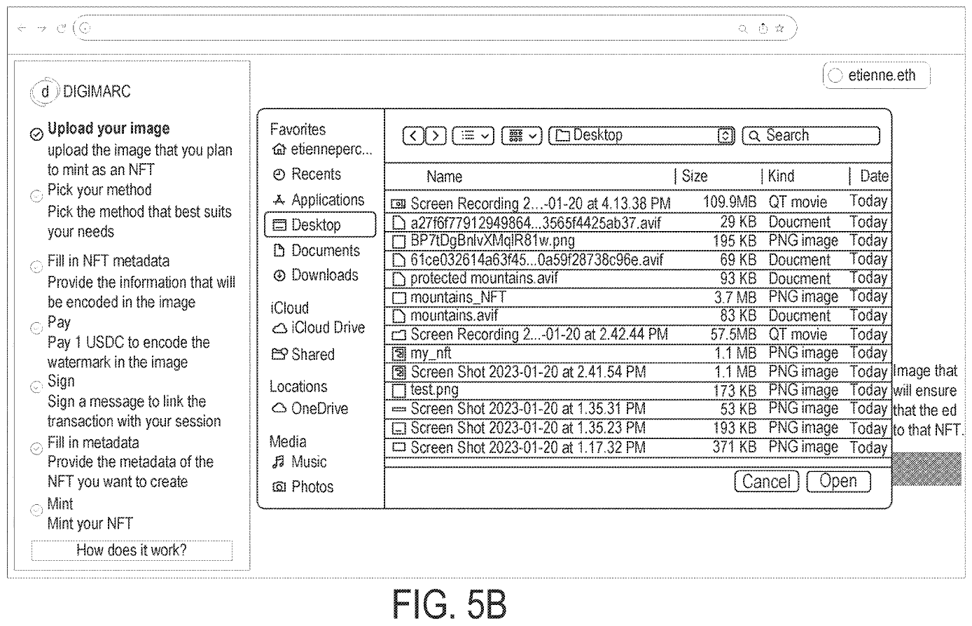

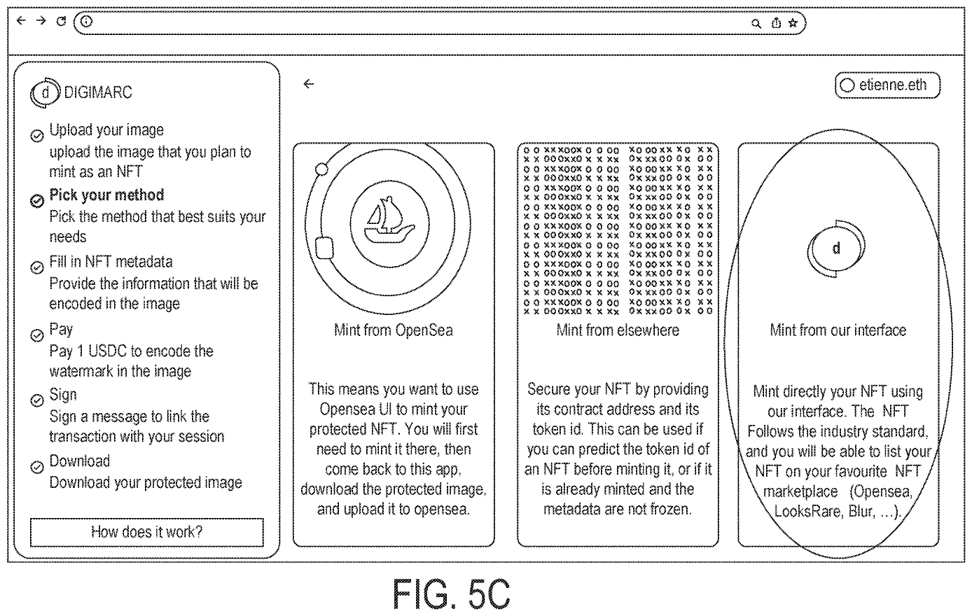

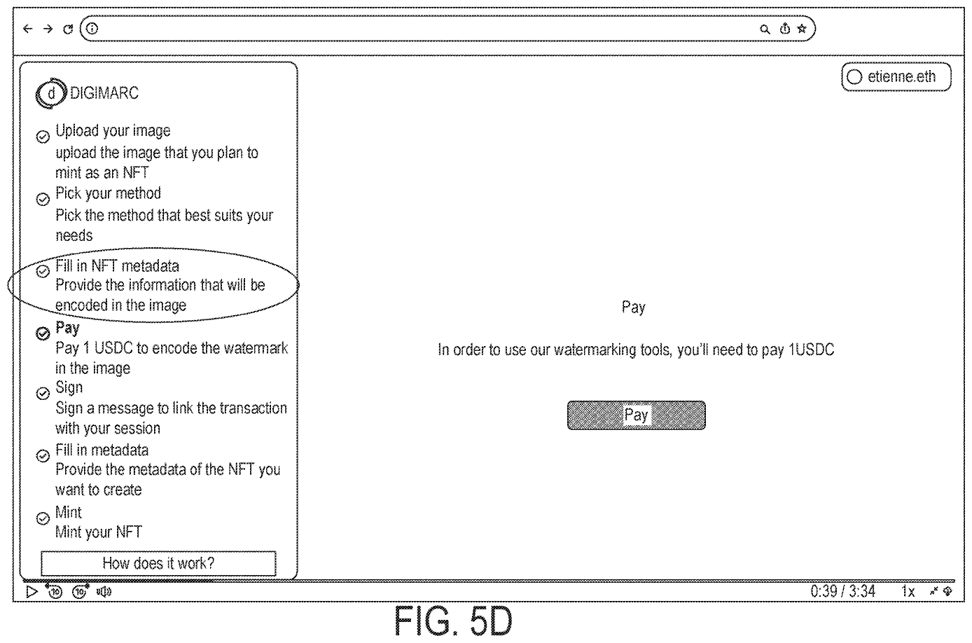

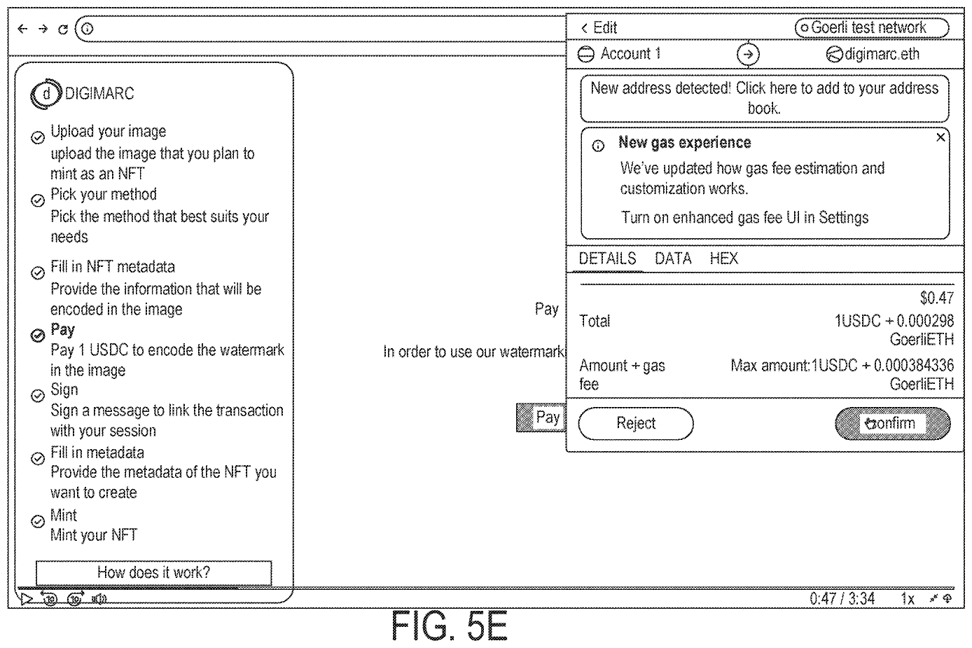

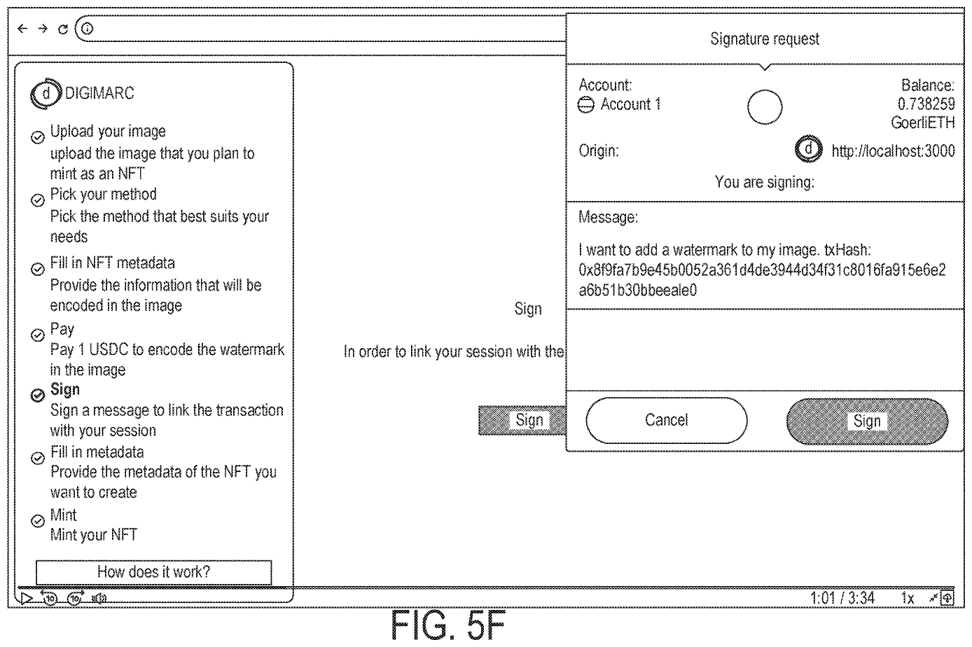

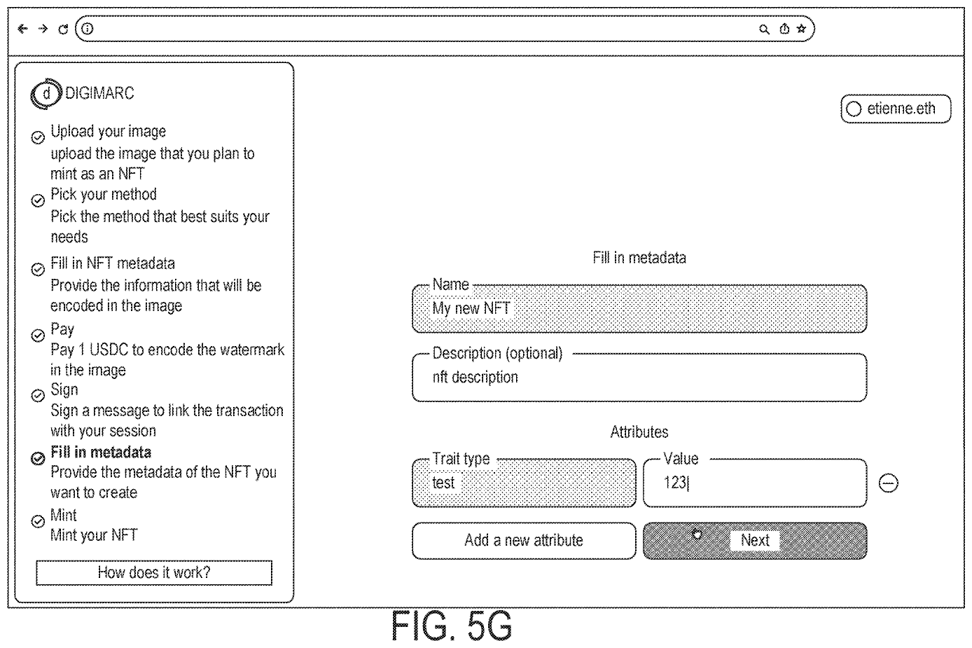

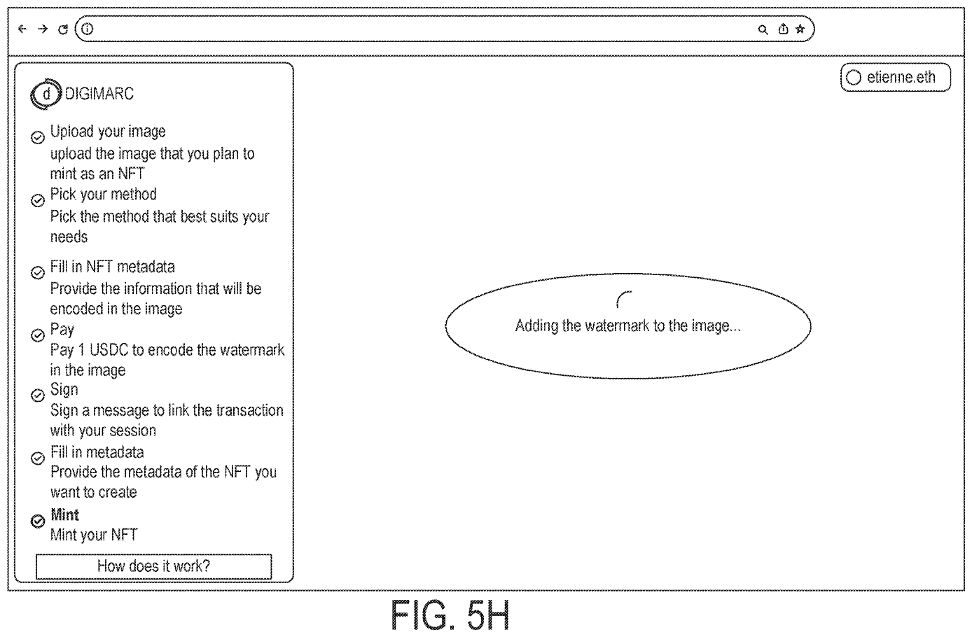

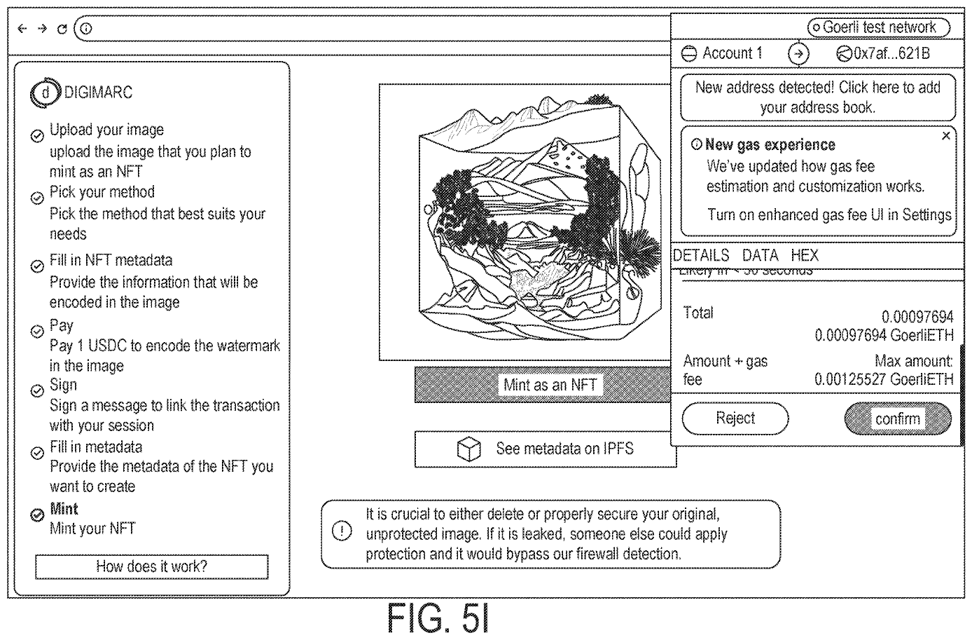

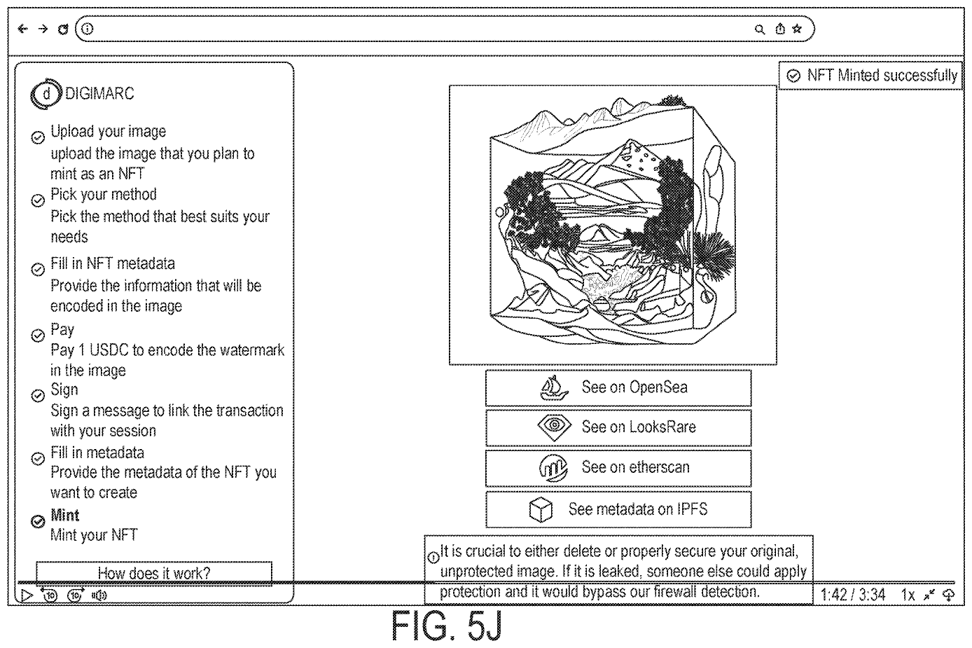

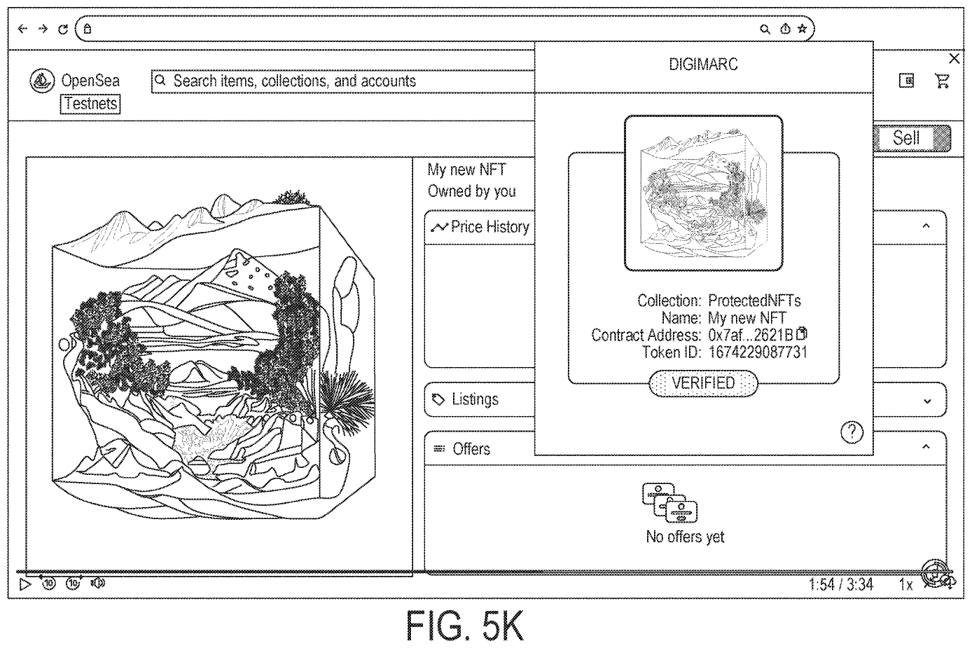

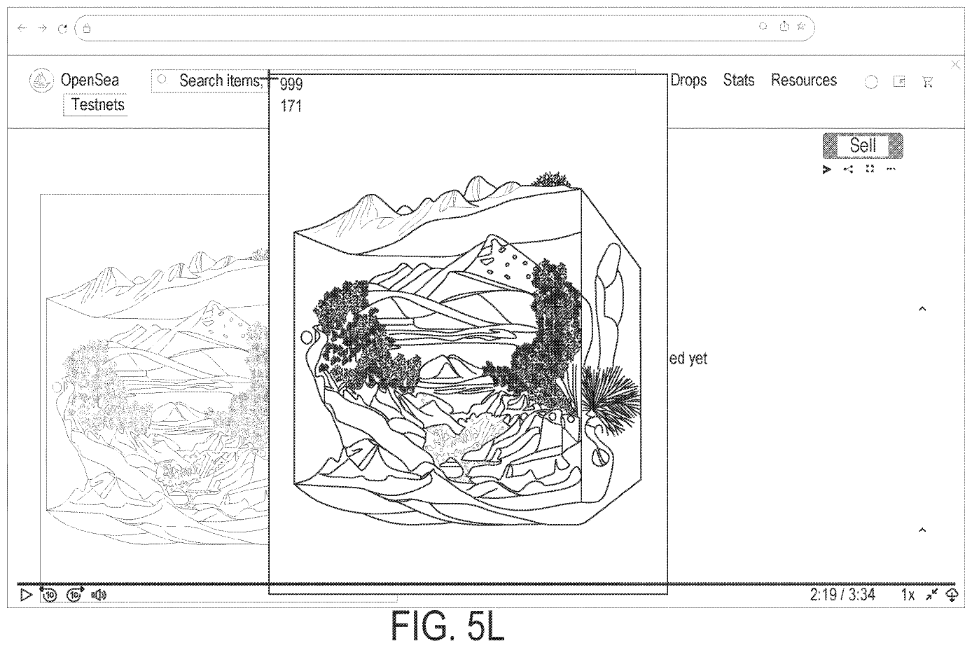

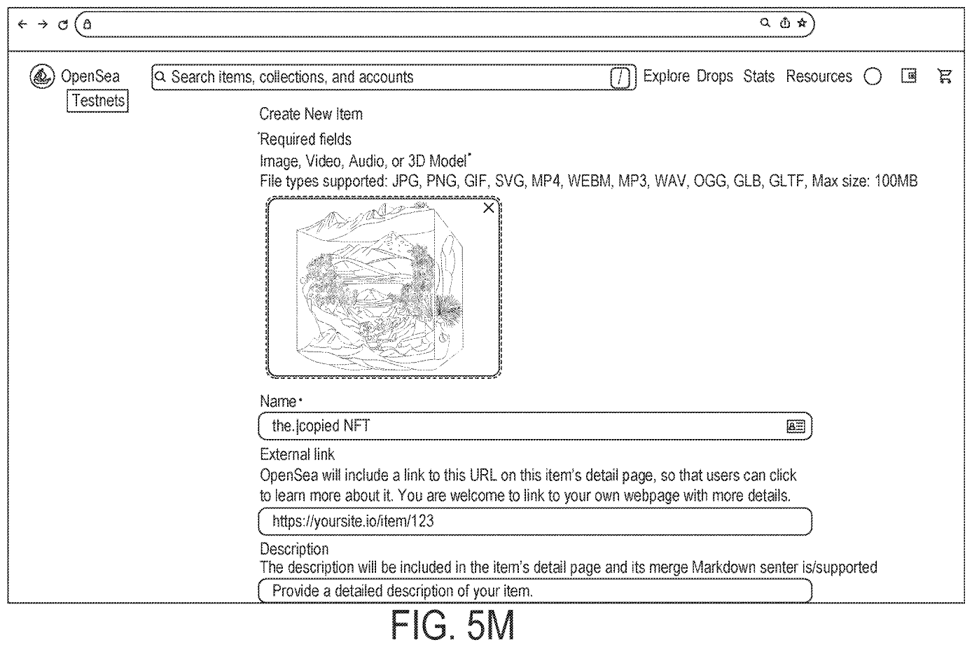

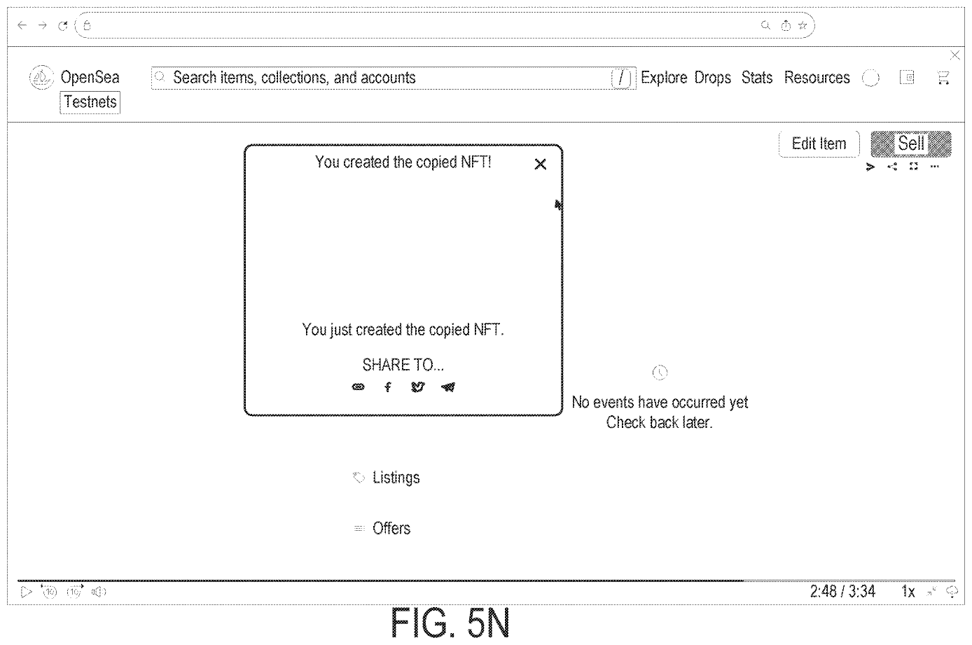

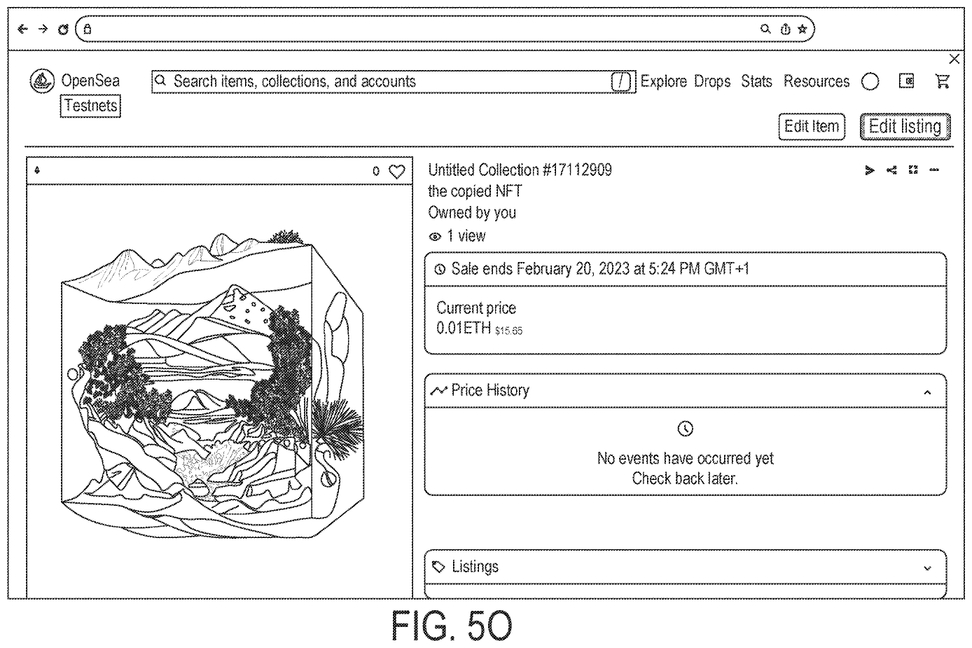

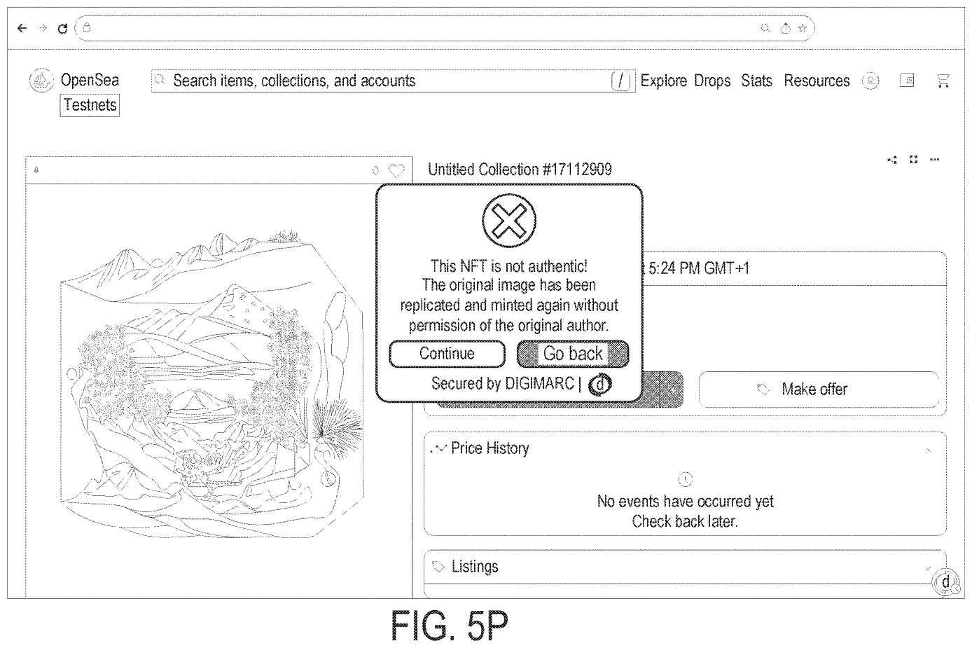

An NFT verification system is now discussed with reference to FIGS. 5A-5P. The NFT verification system operates to protect the integrity of NFT offerings through digital watermarking. The NFT verification system includes two primary components, an NFT authorizing module and an NFT verification module. The NFT authoring system embeds digital watermarking (including a plural-bit payload) within NFT digital content. The payload comprises information to verify the authenticity of the NFT as discussed below. The information can be encrypted, e.g., using a cryptographic hash. Or a hash can be a reduced-bit representation of information to help accommodate watermark payload capacity requirements. The NFT verification module includes a digital watermark detector, which analyzes NFT digital content in search of embedded digital watermarks.

An NFT authorizing module is provided to author an NFT. The NFT authorizing module may include, e.g., software instructions executing on one or more multi-core processors, e.g., two or more multi-core parallel processors, that provides a graphical hosting environment. The graphical hosting environment includes a plurality of graphical user interfaces. The software instructions may include, call and/or communicate with a variety of other modules, networks and systems, e.g., a digital watermarking embedder, digital watermark decoder, NFT networks (e.g., blockchains), and payment services and wallets. The NFT authoring module may be stored locally relative to an NFT creator, but is commonly hosted on a remote network, as are the variety of other modules.

With reference to FIG. 5A, an NFT authorizing module provides a graphical interface to upload digital content, e.g., a digital image. It should be understood that while a digital image is discussed relative to FIGS. 5A-5P, other forms of digital content, such as video, photographs, graphics, artwork, metaverse assets and audio, can be alternatively protected using the described NFT verification system. Uploaded digital content will be minted to create an NFT. Once an interface button is selected, a file search window is presented (see FIG. 5B) through which a creator can select a digital image for minting. Of course, the digital image may be stored local with respect to the creator, but is often located remotely, e.g., in a cloud-drive. FIG. 5C shows an interface through which a creator can select a preferred mechanism to mint their NFT. While the “Mint from our interface” mechanism is specifically discussed below, options for other minting services are accommodated. For example, if using the “Mint from OpenSea” or “Mint from elsewhere” options, the creator would have a button, link or interface through which to provide NFT metadata, e.g., via a “Fill in NFT metadata interface (see circled link in FIG. 5D). The NFT metadata may include, e.g., contract address, blockchain ID and NFT tokenID. This metadata, or a hash thereof, can be carried by a digital watermark payload. Now let's proceed along the “Mint from our interface” flow path.

Once the “Mint from our interface” option is selected, a user interface is provided (see FIG. 5E) that allows the NFT creator to link to a payment session for minting an NFT. After successful payment, the creator selects a “sign” option (FIG. 5F). The signature step uniquely links the payment transaction to the current session, ensuring that a third party cannot use or spoof the payment transaction of a different transaction.

The creator is prompted to add other information in FIG. 5G, such as a name and description for the NFT, and NFT attributes such as type and value. (This interface is provided here since we are following a path along the “mint from our interface.” This entered information is only utilized for the NFT minting process, which could be done somewhere else, e.g., having previously selected the “mint from OpenSea” interface.) Once finished, the process moves on to embedding (e.g., digital watermarking) the metadata into the digital content. See FIG. 5H. The NFT authorizing module may include a digital watermark embedding module or, alternatively, communicate with or call a remotely located digital watermarking embedding module. Suitable digital watermark embedding techniques are discussed above in Section I of this patent document, including within the incorporated by reference patent documents. After successfully paying for the transaction, a digital watermark is added to the original digital image. For example, in one implementation discussed above, the watermark data includes a cryptographic or other hash of the NFT's TokenID, blockchain identifier, and smart contract address. The hash is carried as a digital watermark payload. In another implementation, the watermark data comprises a plain text representation of the smart contract, blockchain identifier and the NFT TokenID, or a cryptographically encoded version, e.g., using a public/private key pair. Other digital watermark data and signature options are available, e.g., as discussed in this patent document. The NFT metadata can be frozen, e.g., by uploading such to an IPFS URI.

After digital watermarking, the NFT is ready for minting. See FIG. 5I. This may involve an additional fee. The NFT authorizing tool includes, communicates with or calls a digital wallet to facilitate payment. The payment may also include a so-called “gas” fee to encourage blockchain validators/minors to process the NFT minting transaction. Once minted, the NFT can be viewed on well-known marketplaces, e.g., OpenSea. See FIG. 5J. (Typically, as long as a particular NFT utilizes a standard, e.g., ERC 721 on EVM, the minted NFT should be visible on all compliant marketplaces built on the EVM/Ethereum standard.) The minted NFT includes a digital watermark embedded within the digital content. The digital watermark provides a link between the NFT metadata and the NFT's associated digital content.

The NFT validation module is used to help determine authenticity of NFTs and their associated digital content. The NFT validation module deploys a digital watermark detector to verify the authenticity of the newly minted NFT. One implementation of an NFT validation module includes a dedicated web browser extension. Such extensions are typically software programs that can modify and enhance the functionality of a web browser. Extensions can be written using, e.g., HTML, CSS (Cascading Style Sheets), and/or JavaScript. The web browser extension can deploy a digital watermark detector, e.g., via decoder code incorporated via software instructions within the extension or, alternatively, called from the web browser extension. If the web browser extension calls a remotely located digital watermark detector, the extension can provide the digital content to the digital watermark detector. In another embodiment, the web browser extension provides an address hosting the digital content to the digital watermark detection, which accesses the digital content by visiting the address. The web browser extension allows users to verify the authenticity of non-fungible tokens (NFTs) and associated digital content on certain marketplace websites. For example, the web browser extension, running in the background and/or once activated (e.g., clicking on an icon or displayed widget), deploys a digital watermark detector to analyze the NFT's digital content. The digital watermark detector analyzes the digital image to locate and decode a plural-bit payload carried therein. The web browser extension includes functionality, e.g., provided by software instructions, to scrape the web page for information to compare against the decoded watermark payload. For example, some NFT marketplaces display text corresponding to the NFT tokenID, blockchain identifier and contract address. Additionally, or alternatively, such information can be typically found in the URL's web page (e.g., in HTML or CSS) of a given marketplace or accessed via a marketplace API. If the digital watermark payload includes a hash of such values, the web browser extension can generate a hash of the scraped or collected information using the same algorithm (or key set) as was used to create the digital watermark payload. Alternatively, the web browser extension can call a 3-party authentication service, provide scrapped information to the service, which generates a corresponding hash, if used, for checking against the decoded watermark payload's hash. In FIG. 5K, the NFT is verified when the digital watermark payload and the generated hash (or plain text, if that's what's carried by the payload) correspond in the expected manner (e.g., match, match within a tolerance, or relate through a cryptographic relationship). A popup window, generated by the web browser extension, can display NFT metadata and whether the NFT has been verified.

Now with reference to FIGS. 5L-5P, consider an NFT counterfeit attempt. A screen shot (or simply a “right-click” copy function) is taken of the displayed NFT's digital content (FIG. 5L). To be sure, this is an unauthorized copy of the digital content. But the unauthorized copy carries the digital watermark as well. That digital watermark includes a payload which is directly linked to the original NFT. An unscrupulous creator now creates a different NFT (named “the copied NFT”) using the screen shot of the digital content (FIG. 5M), and successfully mints the copied NFT (FIG. 5N). The copied NFT is listed for sale on a market platform, e.g., OpenSea (see FIG. 5O, “O” as in “Oscar”). Luckily, a dedicated web browser extension is available for a validation check. The web browser extension running in the background and/or once activated (e.g., clicking on an icon or displayed widget) deploys a digital watermark detector to analyze the copied NFT's digital content. The digital watermark detector analysis the digital image to locate and decode a plural-bit payload carried therein. In this example, the payload includes the original NFT's hashed metadata: i) NFT TokenID, ii) blockchain identifier, and iii) contract address. All of these elements correspond to the original NFT, but will not match all of the metadata in the copied NFT. (For example, the copied NFT could have the same: i) TokenID and contract address, but not the same blockchain ID; or ii) the same contract address and block chain ID, but not the same tokenID, or iii) the same tokenID and blockchainID, but not the same contract address.) The web browser extension scrapes or collects information from the web page hosting the copied NFT for information to compare against the decoded digital watermark payload. The web browser extension finds the NFT TokenID, the blockchain identifier and the contract address of the copied NFT. At least some of the original NFT's metadata is not the same as the copied NFT. So, any cryptographic hash, reduced-bit representation hash or other digital watermark payload comparison will fail. In FIG. 5P, the NFT is shown to be not authentic since a decoded digital watermark payload (decoded from the copied NFT, but corresponding to the original NFT) and the generated hash from information for the copied NFT do not correspond in an expected manner (e.g., do not match, do not match within a tolerance, or do not relate through a cryptographic relationship). A popup window, generated by the web browser extension, can display NFT metadata and that the NFT is not authentic.

An alternative validation scenario includes not finding a digital watermark within an NFT's digital content. A popup window or other display can be generated to communicate that no digital watermark was found within the digital content. This doesn't mean that the NFT is a copy, just that the NFT minting did not include digital watermarking.

Instead of the NFT validating module using a web browser extension, a smartphone running an NFT validation app could be used to search for digital watermarking included with NFT digital content. For example, a smartphone captures an image of NFT digital content from a computer or smartphone display, and then decodes a digital watermark payload embedded within. A user can capture another image of the NFT text for comparison, or manually enters or links to NFT metadata. A digital watermark comparison can be carried out as discussed above to determine authenticity.

Instead of using a browser extension, the NFT validation module, including the detection and validation features discussed above with reference to FIGS. 5K-5P, can be incorporated into a standalone application or service, which queries particular marketplace URI's. For example, an NFT marketplace (e.g., OpenSea) could build the NFT validation module into their platform, e.g., as a feature available to listed NFTs. In an alternative, a plug-in (e.g., a marketplace plug-in) is used instead of a browser extension. In still another alternative, the detection and validation features are provided by a webpage or web service which queries the particular marketplace URI's.

As for a creator, they may want to determine whether their NFT digital content has been copied. They can initiate a search on a monitoring platform that accesses blockchain nodes. Such nodes then can be crawled looking for digital content, and upon encountering such, analyze the digital content for digital watermarking embedded therein. If a digital watermark payload is signed, signatures decoded from the digital watermarking can be compared against that particular creator's signatures to identify potential copies. A signature comparison (using a decoded signature and a generated signature from NFT metadata) can identify unauthorized copies. Alternatively, technologies such as Google lens can be deployed to find copies. A similar digital watermark payload comparison can be carried out to test found copies. Alternatively, a validation module could notify an artist when a copied NFT is found. This notification can be “crowd-sourced” thanks to the plugin, extension or application users who browse NFT marketplaces and authenticate NFTs and their associated digital content.

### CONCLUDING REMARKS

The technology, modules, functionality, methods, processes, and systems described above may be implemented in hardware, software or a combination of hardware and software. For example, the NFT authorizing module and the NFT validation module described above may be implemented as instructions stored in a memory and executed in one or more processors (including both software and firmware instructions), implemented as digital logic circuitry in a special purpose digital circuit, or combination of instructions executed in one or more multi-core processors, one or more parallel processors and/or one or more digital logic circuit modules. For example, the NFT authorizing module and the NFT validation module described above may be implemented as instructions stored in a memory and executed in one or more multi-core processors (including both software and firmware instructions), implemented as digital logic circuitry in a special purpose digital circuit, or combination of instructions executed in one or more multi-core processors, one or more parallel processors and/or one or more digital logic circuit modules. The technology, modules, methods, services, functionality and processes described above may be implemented in programs executed from a system's memory (a non-transitory computer readable medium, such as an electronic, optical or magnetic storage device). The methods, instructions and circuitry operate on electronic signals, or signals in other electromagnetic forms. These signals further represent physical signals like image signals captured in image sensors, audio captured in audio sensors, as well as other physical signal types captured in sensors for that type. These electromagnetic signal representations are transformed to different states as detailed above to detect signal attributes, perform pattern recognition and matching, determine relative attributes of Scans, etc.

Example hardware and communication flow between electronic devices, networks and cloud-based services (provided by cloud-based computers) is further detailed in our PCT Application No. PCT/US22/50767, published as WO 2023/096924, which is hereby incorporated here by reference including all drawings, particularly relative to FIGS. 14, 15 and 16 of that PCT application, and we expressly intend to use those described computing environments with the technology described in the present patent document as if reproduced word for word herein. For example, the NFT authorizing module may be hosted on a cloud resource. Another example is hosting creator hashes or lists on a cloud resource. Another example is hosting a digital watermark embedder and/or digital watermark detector on a cloud resource.

Having described and illustrated the principles of the technology with reference to specific implementations, it will be recognized that the technology can be implemented in many other, different, forms. To provide a comprehensive disclosure without unduly lengthening the specification, applicants incorporate by reference—in their entirety—the patents and patent applications referenced above, including all drawings, and any appendices.

The particular combinations of elements and features in the above-detailed embodiments are exemplary only; the interchanging and substitution of these teachings with other teachings in this and the incorporated-by-reference patents/applications are also contemplated. Any headings used in this document are for the reader's convenience and are not intended to limit the disclosure. We expressly contemplate combining the subject matter under the various headings.

What is claimed is:

1. An image processing method comprising:
obtaining digital content comprising visual elements;
minting a non-fungible token (“NFT”) associated with the digital content, said minting yielding a token identifier generated by a smart contract deployed on a Distributed Ledger Technology (“DLT”), the smart contract having an associated smart contract address and the DLT being associated with a DLT identification;
generating a hash of the token identifier, the smart contract address and the DLT identification, the hash comprising a reduce-bit representation of the token identifier, the smart contract address and the DLT identification; and
using a digital watermark embedder, embedding the hash within the digital content as a digital watermark payload, said embedding yielding digital watermarked digital content, whereby the digital watermarked digital content comprises a link between the digital content and the NFT via the hash.

2. The image processing method of claim 1 further comprising adding the digital watermarked digital content to a marketplace associated with the NFT.

3. The image processing method of claim 1 in which the digital watermark embedder comprises a reversible digital watermarking embedder.

4. The image processing method of claim 1 in which the digital watermark embedder embeds a synchronization signal within the digital content, wherein the synchronization signal helps determine scale and rotation for successful payload decoding.

5. The image processing method of claim 1 further comprising:
generating a fingerprint representing the visual elements of the digital content; and in which said generating generates a hash of the fingerprint, the token identifier, the smart contract address and the DLT identification.

6. The image processing method of claim 5 further comprising:
prior to said generating, generating a signature using a private key, the signature comprising a cryptographic relationship based on the private key of the fingerprint, the token identifier, the smart contract address and the DLT identification; and in which said generating generates a hash of the signature, whereby the digital watermarked digital content comprises a link between the digital content and the NFT via the cryptographic relationship.

7. The image processing method of claim 1 further comprising:
prior to said generating, generating a signature using a private key, the signature comprising a cryptographic relationship based on the private key of the token identifier, the smart contract address and the DLT identification; and in which said generating generates a hash of the signature, whereby the digital watermarked digital content comprises a link between the digital content and the NFT via the cryptographic relationship.

8. A method of creating a cryptographic ownership chain for a non-fungible token using digital watermarking, said method comprising:
obtaining digital content comprising visual elements, the digital content comprising a first digital watermark embedded therein, the first digital watermark comprising a first plural-bit payload carrying a creator signature comprising a cryptographic relationship between a smart contract address and a target blockchain according to a first private key, the digital content being associated with a non-fungible token (“NFT”);
decoding the first plural-bit payload to obtain the creator signature;
embedding a second digital watermark within the digital content, the second digital watermark comprising a second plural-bit payload carrying a first owner signature, the first owner signature comprising a hashed version of the creator signature using a second private key, in which the embedding of the second digital watermark is associated with ownership transfer of the digital content from the creator to the first owner.

9. The method of claim 8 in which the first digital watermark is embedded within the digital content using reversible digital watermarking, and in which said decoding further comprises removing the first digital watermark from the digital content so that, after said embedding, the digital content no longer comprises the first digital watermark.

10. The method of claim 8 in which said embedding layers the second digital watermark within the digital content so that after said embedding, the digital content comprises both the first digital watermark and the second digital watermark.

11. The method of claim 8 further comprising: decoding the second digital watermark to obtain the first owner signature, and embedding a third digital watermark payload within the digital content, the third digital watermark comprising a third plural-bit payload carrying a second owner signature, the second owner signature comprising a hashed version of the first owner signature using a third private key, in which the embedding of the third digital watermark is associated with an ownership transfer of the digital content from the first owner to a second owner.

12. The method of claim 11 in which the second digital watermark is embedded within the digital content using reversible digital watermarking, and in which decoding the second digital watermark further comprises removing the second digital watermark from the digital content so that, after said embedding, the digital content no longer comprises the first digital watermark nor the second digital watermark.

13. The method of claim 8 in which said embedding layers the third digital watermark within the digital content so that after said embedding the third digital watermark, the digital content comprises each of the first digital watermark, the second digital watermark and the third digital watermark.

14. The method of claim 8 in which the creator signature comprises a cryptographic relationship between the smart contract address, target blockchain and fingerprint of the visual elements, all according to the first private key.

15. A method comprising:
providing two different digital watermarks to help associate information with non-fungible tokens (“NFTs”), a first of the two different digital watermarks comprising a synchronization signal aligned at a first starting point relative to host digital content, the first starting point indicating a first NFT marketplace, in which the first of the two different digital watermarks does not carry a payload component, and in which the second of the two different digital watermarks comprises only a payload component and no synchronization signal, in which the payload component relies upon the synchronization signal of the first of the two different digital watermarks for decoding, and in which the payload component comprises NFT ownership information;
using a digital watermark decoder, searching digital content to locate the first of the two different digital watermarks and the second of the two different digital watermarks, and making a determination according to decoding results yielded by the digital watermark decoder as follows: when only the first of the two different digital watermarks is found, determining the first NFT marketplace, and when both the first of the two different digital watermarks and the second of the two different digital watermarks are found, determining a current owner of the digital watermark from the NFT ownership information.

16. The method of claim 15 in which the synchronization signal can be aligned within the digital content at 16 K different starting points.

17. The method of claim 15 in which the synchronization signal can be aligned within the digital content at 4 K different starting points.

18. The method of claim 15 in which the synchronization signal can be aligned within the digital content at 4 different starting points.

19. The method of claim 15 in which the synchronization signal can be aligned within the digital content between 4 and 16 K different starting points.

20. The method of claim 15 in which the second of the two different digital watermarks is layered within the digital content so as to be aligned with the synchronization signal.

21. An image processing method comprising:
obtaining digital content comprising visual elements;
minting a non-fungible token (“NFT”) associated with the digital content, said minting yielding a token identifier corresponding to a smart contract, hosting address of the NFT and an identifier associated with a Distributed Ledger Technology (“DLT”);
generating data representing the token identifier, the hosting address and the identifier;
embedding, using a digital watermark embedder, the generated data within the digital content, said embedding altering at least some portions of the visual elements, said embedding yielding digital watermarked digital content;
publishing the digital watermarked digital content on the hosting address of the NFT.

22. The image processing method of claim 21 in which said generated data comprises a hash of the token identifier, the hosting address and the identifier, in which the hash comprises a reduced-bit representation of the token identifier, the hosting address and the identifier.

23. The image processing method of claim 21 in which said generated data comprises clear text representing the token identifier, the hosting address and the identifier.

24. The image processing method of claim 22, further comprising:
using one or more multi-core processors:
accessing data representing the digitally watermarked digital content from the hosting address;
analyzing, using a digital watermark decoder, the data representing the digitally watermarked digital content to decode the hash, said analyzing yielding a decoded hash;
scraping information from data associated with the hosting address of the NFT, said scraping yielding a scraped token identifier, a scraped hosting address and a scraped DLT identifier;
generating a comparison hash based on the scraped token identifier, the scraped hosting address and the scraped DLT identifier;
comparing the decoded hash with the comparison hash to determine whether the NFT is authentic.

25. The image processing method of claim 21, further comprising:
using one or more multi-core processors:
accessing data representing the digitally watermarked digital content from the hosting address;
analyzing, using a digital watermark decoder, the data representing the digital watermarked digital content to decode the generated data, said analyzing yielding decoded generated data;
scraping information from data associated with the hosting address of the NFT, said scraping yielding a scraped token identifier, a scraped hosting address and a scraped DLT identifier;
generating comparison scraped data based on the scraped token identifier, the scraped hosting address and the scraped DLT identifier;
comparing the decoded generated data with the comparison scraped data to determine whether the NFT is authentic.

26. The method of claim 21 in which said hosting address of the NFT comprises a URL, and the data associated with the hosting address comprises data found from HTML code, an API, CSS code or JavaScript elements associated with the URL.

27. The method of claim 24 in which said scraping comprises searching within an API, HTML code, JavaScript elements and/or CSS code associated with the hosting address.

28. The method of claim 24 in which said analyzing calls a remotely located a digital watermark decoder.
